(19) United States
(12) Patent Application Publication
(10) Pub. No.: US 2026/0133603 A1
(43) Pub. Date: May 14, 2026

(54) TIME BASED TELEMETRY FOR NETWORKED DEVICES

(71) Applicant: Intel Corporation, Santa Clara, CA (US)

(72) Inventors: Suyog Kulkarni, Portland, OR (US); Daniel Biederman, Saratoga, CA (US); Mitu Aggarwal, Portland, OR (US); Andrzej Kuriata, Gdansk (PL); Yadong Li, Portland, OR (US)

(73) Assignee: Intel Corporation, Santa Clara, CA (US)

(21) Appl. No.: 18/945,869

(22) Filed: Nov. 13, 2024

(51) Int. Cl. G06F 1/12; G06F 13/20

(52) U.S. Cl. CPC G06F 1/12; G06F 13/20

(57) ABSTRACT

Described herein are techniques to enable the generation of sharing of telemetry between network devices and host devices with timestamps that are synchronized at nanosecond precision. One embodiment provides a device comprising a network interface, packet processing circuitry, and a host interface. The device facilitates the synchronization of system and/or device clocks of network and host devices to a common clock. The device is additionally configured to aggregate telemetry having timestamps that are based on the common clock and synchronize the telemetry from the network and host devices.

### BACKGROUND OF THE DISCLOSURE

Telemetry in computational systems generally involves capturing measurements of hardware and software use during a workload. Workloads may include running an application, executing specific instructions, or performing network calls. Telemetry is also used in networking systems to track and monitor the performance of components of the network. However, computing and network telemetry systems are not generally designed to interact with one another.

### BRIEF DESCRIPTION OF THE DRAWINGS

Embodiments described herein are illustrated by way of example and not limitation in the figures of the accompanying drawings in which like references indicate similar elements, and in which:

FIG. 1 is a block diagram illustrating a computer system configured to implement one or more aspects of the embodiments described herein;

FIG. 2 is a block diagram of a system that includes selected components of a datacenter;

FIG. 3 is a block diagram of a portion of a datacenter, according to one or more examples of the present specification;

FIG. 4A-4C illustrates programmable forwarding elements and adaptive routing;

FIG. 5A-5B depicts example network interface devices;

FIG. 6 is a block diagram illustrating a programmable network interface and data processing unit;

FIG. 7 is a block diagram illustrating an IP core development system;

FIG. 8A-8B illustrates techniques to enable in-band network telemetry and time synchronization;

FIG. 9A-9B illustrates systems that implement precision time measurement over a host interconnect;

FIG. 10 illustrates a programmable network interface device that is configurable as a multi-domain time source;

FIG. 11A-11C illustrate multi-domain time synchronization modes, according to embodiments;

FIG. 12A-12B illustrates systems to enable multi-device telemetry aggregation, according to an embodiment;

FIG. 13 illustrates a warehouse computing system with synchronized multi-domain time and telemetry, according to an embodiment; and

FIG. 14 illustrates a method of enabling time-based telemetry for networked devices, according to an embodiment.

### DETAILED DESCRIPTION

In existing datacenter environments, processors, accelerators, and network devices use different and independent telemetry systems. However, significant maintenance, debugging, and development advantages may be realized by the ability to track processor, accelerator, and network events via common telemetry. Described herein are techniques to enable the sharing of telemetry between network interface devices, host-based central processing units (CPUs), parallel processors, and accelerator devices that are interconnected via system interconnect fabrics and over a network. The shared telemetry data can include, be accompanied by, and/or facilitated via shared time synchronization data that provides a common precise time for use by a distributed system and/or warehouse computer. The common precise time enables the determination of a timeline of events that are occurring throughout a warehouse computer at a higher level of accuracy and precision that is capable with existing time protocols. Additionally, the use of a common precise time across devices connected via system interconnect fabrics and networks enables time-based scheduling of events across a warehouse computer.

In the following description, numerous specific details are set forth to provide a more thorough understanding. However, it will be apparent to one of skill in the art that the embodiments described herein may be practiced without one or more of these specific details. In other instances, well-known features have not been described to avoid obscuring the details of the present embodiments.

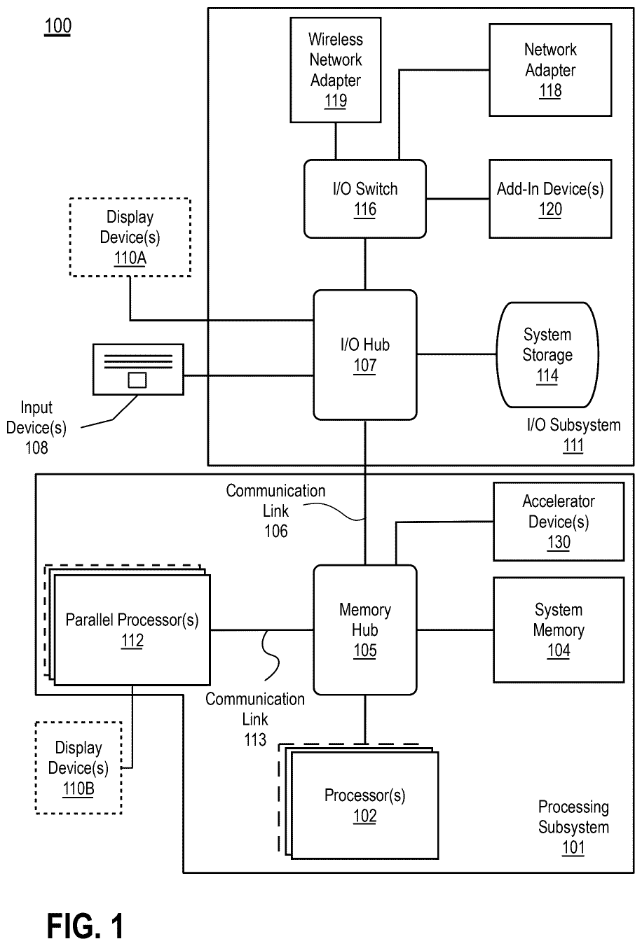

FIG. 1 is a block diagram illustrating a computing system 100 configured to implement one or more aspects of the embodiments described herein. The computing system 100 includes a processing subsystem 101 having one or more processor(s) 102, such as central processing units (CPUs) or other host processors, and a system memory 104, which may communicate via an interconnection path that may include a memory hub 105. The memory hub 105 may be a separate component within a chipset component or may be integrated within the one or more processor(s) 102. The memory hub 105 couples with an I/O subsystem 111 via a communication link 106. The I/O subsystem 111 includes an I/O hub 107 that can enable the computing system 100 to receive input from one or more input device(s) 108. Additionally, the I/O hub 107 can enable a display controller, which may be included in the one or more processor(s) 102, to provide outputs to one or more display device(s) 110A. In one embodiment the one or more display device(s) 110A coupled with the I/O hub 107 can include a local, internal, or embedded display device.

The processing subsystem 101, for example, includes one or more parallel processor(s) 112 coupled to memory hub 105 via a communication link 113, such as a bus or fabric. The communication link 113 may be one of any number of standards-based communication link technologies or protocols, such as, but not limited to PCI Express, or may be a vendor specific communications interface or communications fabric. The one or more parallel processor(s) 112 may form a computationally focused parallel or vector processing system that can include a large number of processing cores and/or processing clusters, such as a many integrated core (MIC) processor. For example, the one or more parallel processor(s) 112 form a graphics processing subsystem that can output pixels to one of the one or more display device(s) 110A coupled via the I/O hub 107. The one or more parallel processor(s) 112 can also include a display controller and display interface (not shown) to enable a direct connection to one or more display device(s) 110B.

Within the I/O subsystem 111, a system storage unit 114 can connect to the I/O hub 107 to provide a storage mechanism for the computing system 100. An I/O switch 116 can be used to provide an interface mechanism to enable connections between the I/O hub 107 and other components, such as a network adapter 118 and/or wireless network adapter 119 that may be integrated into the platform, and various other devices that can be added via one or more add-in device(s) 120. The add-in device(s) 120 may also include, for example, one or more external graphics processor devices, graphics cards, and/or compute accelerators. The network adapter 118 can be an Ethernet adapter or another wired network adapter. The wireless network adapter 119 can include one or more of a Wi-Fi, Bluetooth, near field communication (NFC), or other network device that includes one or more wireless radios.

The computing system 100 can include other components not explicitly shown, including USB or other port connections, optical storage drives, video capture devices, and the like, which may also be connected to the I/O hub 107. Communication paths interconnecting the various components in FIG. 1 may be implemented using any suitable protocols, such as PCI (Peripheral Component Interconnect) based protocols (e.g., PCI-Express), or any other bus or point-to-point communication interfaces and/or protocol(s), such as the NVLink high-speed interconnect, Compute Express Link™ (CXL™) (e.g., CXL.mem), Infinity Fabric (IF), Ethernet (IEEE 802.3), remote direct memory access (RDMA), InfiniBand, Internet Wide Area RDMA Protocol (iWARP), Transmission Control Protocol (TCP), Internet Protocol (IP), User Datagram Protocol (UDP), quick UDP Internet Connections (QUIC), RDMA over Converged Ethernet (ROCE), Ultra Ethernet Transport (UET), Intel QuickPath Interconnect (QPI), Intel Ultra Path Interconnect (UPI), Intel On-Chip System Fabric (IOSF), Omnipath, HyperTransport, Advanced Microcontroller Bus Architecture (AMBA) interconnect, Open Coherent Accelerator Processor Interface (CAPI), Gen-Z, Cache Coherent Interconnect for Accelerators (CCIX), 3rd Generation Partnership Projects (3GPP) Long Term Evolution (LTE) (e.g., 4th generation (4G)), 3GPP 5th generation (5G), and variations thereof, or wired or wireless interconnect protocols known in the art. In some examples, data can be copied or stored to virtualized storage nodes using a protocol such as non-volatile memory express (NVMe) over Fabrics (NVMe-oF) or NVMe. In one embodiment, time-aware communication protocols are supported, including time-aware RDMA, time-aware NVME, and time-aware NVME-oF, in which a precise time and rate of data consumption is used to control the transfer of data.

The one or more parallel processor(s) 112 may incorporate circuitry optimized for graphics and video processing, including, for example, video output circuitry, and constitutes a graphics processing unit (GPU). Alternatively or additionally, the one or more parallel processor(s) 112 can incorporate circuitry optimized for general purpose processing, while preserving the underlying computational architecture, described in greater detail herein. Components of the computing system 100 may be integrated with one or more other system elements on a single integrated circuit. For example, the one or more parallel processor(s) 112, memory hub 105, processor(s) 102, and I/O hub 107 can be integrated into a system on chip (SoC) integrated circuit. Alternatively, the components of the computing system 100 can be integrated into a single package to form a system in package (SiP) configuration. In one embodiment at least a portion of the components of the computing system 100 can be integrated into a multi-chip module (MCM), which can be interconnected with other multi-chip modules into a modular computing system.

In some configurations, the computing system 100 includes one or more accelerator device(s) 130 coupled with the memory hub 105, in addition to the processor(s) 102 and the one or more parallel processor(s) 112. The accelerator device(s) 130 are configured to perform domain specific acceleration of workloads to handle tasks that are computationally intensive or require high throughput. The accelerator device(s) 130 can reduce the burden placed on the processor(s) 102 and/or parallel processor(s) 112 of the computing system 100. The accelerator device(s) 130 can include but are not limited to smart network interface cards, data processing units, cryptographic accelerators, storage accelerators, artificial intelligence (AI) accelerators, neural processing units (NPUs), storage accelerators, and/or video transcoding accelerators.

It will be appreciated that the computing system 100 shown herein is illustrative and that variations and modifications are possible. The connection topology, including the number and arrangement of bridges, the number of processor(s) 102, and the number of parallel processor(s) 112, may be modified as desired. For instance, system memory 104 can be connected to the processor(s) 102 directly rather than through a bridge, while other devices communicate with system memory 104 via the memory hub 105 and the processor(s) 102. In other alternative topologies, the parallel processor(s) 112 are connected to the I/O hub 107 or directly to one of the one or more processor(s) 102, rather than to the memory hub 105. In other embodiments, the I/O hub 107 and memory hub 105 may be integrated into a single chip. It is also possible that two or more sets of processor(s) 102 are attached via multiple sockets, which can couple with two or more instances of the parallel processor(s) 112.

Some of the particular components shown herein are optional and may not be included in all implementations of the computing system 100. For example, any number of add-in cards or peripherals may be supported, or some components may be eliminated. Furthermore, some architectures may use different terminology for components similar to those illustrated in FIG. 1.

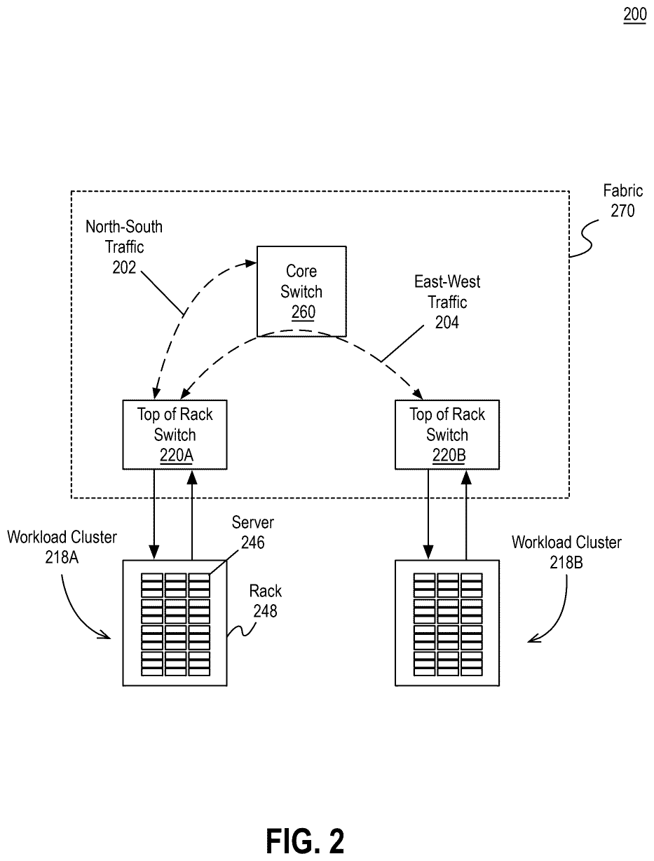

FIG. 2 is a block diagram of a system 200 that includes selected components of a datacenter. The components of the illustrated datacenter may reside, for example within a cloud service provider (CSP), or another datacenter, which may be, by way of nonlimiting example, a traditional enterprise datacenter, an enterprise “private cloud,” or a “public cloud,” providing services such as infrastructure as a service (IaaS), platform as a service (PaaS), or software as a service (SaaS). The system 200 includes some number of workload clusters, including but not limited to workload cluster 218A and workload cluster 218B. The workload clusters may be clusters of individual servers, blade servers, rackmount servers, or any other suitable server topology.

The system 200 may include workload clusters 218A-218B. The workload clusters 218A-218B can include a rack 248 that houses multiple servers (e.g., server 246). The rack 248 and the servers of the workload clusters 218A-218B may conform to the rack unit (“U”) standard, in which one rack unit conforms to a 19 inch wide rack frame and a full-sized industry standard rack accommodates 42 units (42 U) of equipment. One unit (1 U) of equipment (e.g., a 1 U server) may be 1.75 inches high and approximately 36 inches deep. In various configurations, compute resources such as processors, memory, storage, accelerators, and switches may fit into some multiple of rack units within a rack 248.

A server 246 may host a standalone operating system configured to provide server functions, or the servers may be virtualized. A virtualized server may be under the control of a virtual machine manager (VMM), hypervisor, and/or orchestrator, and may host one or more virtual machines, virtual servers, or virtual appliances. The workload clusters 218A-218B may be collocated in a single datacenter, or may be located in different geographic datacenters. Depending on the contractual agreements, some servers may be specifically dedicated to certain enterprise clients or tenants while other servers may be shared.

The various devices in a datacenter may be interconnected via a switching fabric 270, which may include one or more high speed routing and/or switching devices. The switching fabric 270 may provide north-south traffic 202 (e.g., traffic to and from the wide area network (WAN), such as the internet), and east-west traffic 204 (e.g., traffic across the datacenter). Historically, north-south traffic 202 accounted for the bulk of network traffic, but as web services become more complex and distributed, the volume of east-west traffic 204 has risen. In many datacenters, cast-west traffic 204 now accounts for the majority of traffic. Furthermore, as the capability of a server 246 increases, traffic volume may further increase. For example, a server 246 may provide multiple processor slots, with a slot accommodating a processor having four to eight cores, along with sufficient memory for the cores. Thus, a server may host a number of VMs that may be a source of traffic generation.

To accommodate the large volume of traffic in a datacenter, a highly capable implementation of the switching fabric 270 may be provided. The illustrated implementation of the switching fabric 270 is an example of a flat network in which a server 246 may have a direct connection to a top-of-rack switch (ToR switch 220A-220B) (e.g., a “star” configuration). ToR switch 220A can connect with a workload cluster 218A, while ToR switch 220B can connect with workload cluster 218B. A ToR switch 220A-220B may couple to a core switch 260. This two-tier flat network architecture is shown only as an illustrative example and other architectures may be used, such as three-tier star or leaf-spine (also called “fat tree” topologies) based on the “Clos” architecture, hub-and-spoke topologies, mesh topologies, ring topologies, or 3-D mesh topologies, by way of nonlimiting example.

The switching fabric 270 may be provided by any suitable interconnect using any suitable interconnect protocol. For example, a server 246 may include a fabric interface (FI) of some type, a network interface card (NIC), or other host interface. The host interface itself may couple to one or more processors via an interconnect or bus, such as PCI, PCIe, or similar, and in some cases, this interconnect bus may be considered to be part of the switching fabric 270. The switching fabric may also use PCIe physical interconnects to implement more advanced protocols, such as compute express link (CXL).

The interconnect technology may be provided by a single interconnect or a hybrid interconnect, such as where PCIe provides on-chip communication, 1 Gb or 10 Gb copper Ethernet provides relatively short connections to a ToR switch 220A-220B, and optical cabling provides relatively longer connections to core switch 260. Interconnect technologies include, by way of nonlimiting example, Ultra Path Interconnect (UPI), FibreChannel, Ethernet, FibreChannel over Ethernet (FCOE), InfiniBand, PCIe, NVLink, or fiber optics, to name just a few. Some of these will be more suitable for certain deployments or functions than others, and selecting an appropriate fabric for the instant application is an exercise of ordinary skill.

In one embodiment, the switching elements of the switching fabric 270 are configured to implement switching techniques to improve the performance of the network in high usage scenarios. Exemplary advanced switching techniques include but are not limited to adaptive routing, adaptive fault recovery, and adaptive and/or telemetry-based congestion control.

Adaptive routing enables a ToR 220A-220B switch and/or core switch 260 to select the output port to which traffic is switched based on the load on the selected port, assuming unconstrained port selection is enabled. An adaptive routing table can configure the forwarding tables of switches of the switching fabric 270 to select between multiple ports between switches when multiple connections are present between a given set of switches in an adaptive routing group. Adaptive fault recovery (e.g., self-healing) enables the automatic selection of an alternate port if the ported selected by the forwarding table port is in a failed or inactive state, which enables rapid recovery in the event of a switch-to-switch port failure. A notification can be sent to neighboring switches when adaptive routing or adaptive fault recovery becomes active in a given switch. Adaptive congestion control configures a switch to send a notification to neighboring switches when port congestion on that switch exceeds a configured threshold, which may cause those neighboring switches to adaptively switch to uncongested ports on that switch or switches associated with an alternate route to the destination.

Telemetry-based congestion control uses real-time monitoring of telemetry from network devices, such as switches within the switching fabric 270, to detect when congestion will begin to impact the performance of the switching fabric 270 and proactively adjust the switching tables within the network devices to prevent or mitigate the impending congestion. A ToR 220A-220B switch and/or core switch 260 can implement a built-in telemetry-based congestion control algorithm or can provide an application programming interface (API) though which a programmable telemetry-based congestion control algorithm can be implemented. A continuous feedback loop may be implemented in which the telemetry-based congestion control system continuously monitors the network and adjusts the traffic flow in real-time based on ongoing telemetry data. Learning and adaptation can be implemented by the telemetry-based congestion control system in which the system can adapt to changing network conditions and improve its congestion control strategies based on historical data and trends.

Note however that while high-end fabrics are provided herein by way of illustration, more generally, the switching fabric 270 may include any suitable interconnect or bus for the particular application, including legacy interconnects used to implement a local area network (LANs), synchronous optical networks (SONET), asynchronous transfer mode (ATM) networks, wireless networks such as Wi-Fi and Bluetooth, 4G wireless, 5G wireless, digital subscriber line (DSL) interconnects, multimedia over coax alliance (MoCA) interconnects, or similar wired or wireless networks. It is also expressly anticipated that in the future, new network technologies will arise to supplement or replace some of those listed here, and any such future network topologies and technologies can be or form a part of the switching fabric 270.

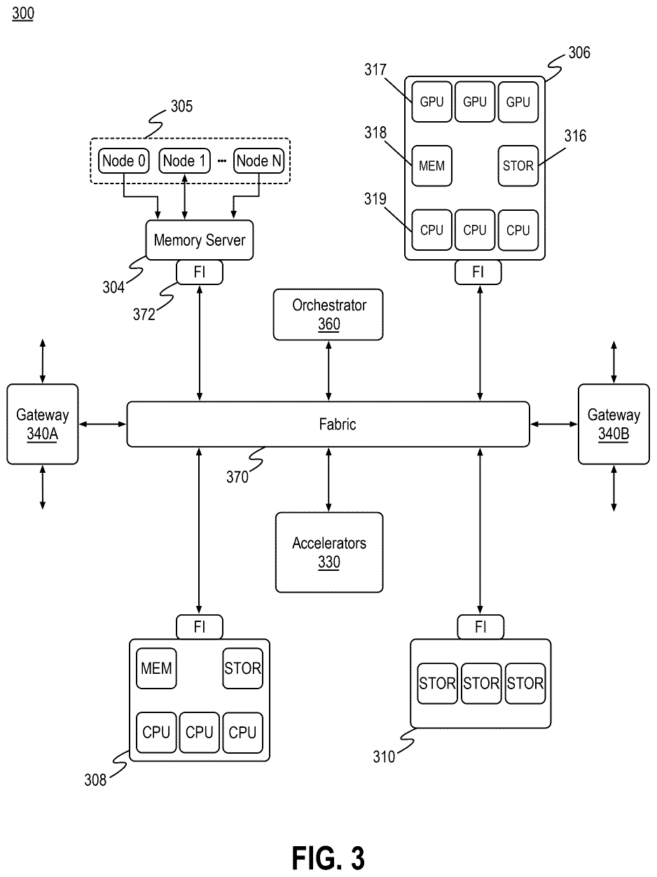

FIG. 3 is a block diagram of a portion of a datacenter 300, according to one or more examples of the present specification. The illustrated portion of the datacenter 300 is not intended to include all components of a datacenter. The illustrated portion may be duplicated multiple times within the datacenter 300 and/or the datacenter 300 may include portions beyond the illustrated portions, depending on the capacity and functionality intended to be provided by the datacenter 300. The datacenter 300 may be, in various embodiments include components of the datacenter of the system 200 of FIG. 2, or may be a different datacenter.

The datacenter 300 includes a number of logic elements forming a plurality of nodes, where a node may be provided by a physical server, a group of servers, or other hardware. A server may also host one or more virtual machines, as appropriate to its application. A fabric 370 is provided to interconnect various aspects of datacenter 300. The fabric 370 may be provided by any suitable interconnect technology, including but not limited to InfiniBand, Ethernet, PCIe, or CXL. The fabric 370 of the datacenter 300 may be a version of and/or include elements of the switching fabric 270 of the system 200 of FIG. 2. The fabric 370 of datacenter 300 can interconnect datacenter elements that include server nodes (e.g., memory server node 304, heterogenous compute server node 306, CPU server node 308, storage server node 310), accelerators 330, gateways 340A-340B to other fabrics, fabric architectures, or interconnect technologies, and an orchestrator 360.

The server nodes of the datacenter 300 can include but are not limited to a memory server node 304, a heterogenous compute server node 306, a CPU server node 308, and a storage server node 310. The heterogenous compute server node 306 and a CPU server node 308 can perform independent operations for different tenants or cooperatively perform operations for a single tenant. The heterogenous compute server node 306 and a CPU server node 308 can also host virtual machines that provide virtual server functionality to tenants of the datacenter.

The server nodes can connect with the fabric 370 via a fabric interface 372. The specific type of fabric interface 372 that is used depends at least in part on the technology or protocol that is used to implement the fabric 370. For example, where the fabric 370 is an Ethernet fabric, the fabric interface 372 may be an Ethernet network interface controller. Where the fabric 370 is a PCIe-based fabric, the fabric interfaces may be PCIe-based interconnects. Where the fabric 370 is an InfiniBand fabric, the fabric interface 372 of the heterogenous compute server node 306 and a CPU server node 308 may be a host channel adapter (HCA), while the fabric interface 372 of the memory server node 304 and storage server node 310 may be a target channel adapter (TCA). TCA functionality may be an implementation-specific subset of HCA functionality. The various fabric interfaces may be implemented as intellectual property (IP) blocks that can be inserted into an integrated circuit as a modular unit, as can other circuitry within the datacenter 300.

The heterogenous compute server node 306 includes multiple CPU sockets that can house a CPU 319, which may be, but is not limited to an Intel® Xeon™ processor including a plurality of cores. The CPU 319 may also be, for example, a multi-core datacenter class ARM® CPU, such as an NVIDIA® Grace™ CPU. The heterogenous compute server node 306 includes memory devices 318 to store data for runtime execution and storage devices 316 to enable the persistent storage of data within non-volatile memory devices. The heterogenous compute server node 306 is enabled to perform heterogenous processing via the presence of GPUs (e.g., GPU 317), which can be used, for example, to perform high-performance compute (HPC), media server, cloud gaming server, and/or machine learning compute operations. In one configuration, the GPUs may be interconnected and CPUs of the heterogenous compute server node 306 via interconnect technologies such as PCIe, CXL, or NVLink.

The CPU server node 308 includes a plurality of CPUs (e.g., CPU 319), memory (e.g., memory devices 318) and storage (storage devices 316) to execute applications and other program code that provide server functionality, such as web servers or other types of functionality that is remotely accessible by clients of the CPU server node 308. The CPU server node 308 can also execute program code that provides services or micro-services that enable complex enterprise functionality. The fabric 370 will be provisioned with sufficient throughput to enable the CPU server node 308 to be simultaneously accessed by a large number of clients, while also retaining sufficient throughput for use by the heterogenous compute server node 306 and to enable the use of the memory server node 304 and the storage server node 310 by the heterogenous compute server node 306 and the CPU server node 308. Furthermore, in one configuration, the CPU server node 308 may rely primarily on distributed services provided by the memory server node 304 and the storage server node 310, as the memory and storage of the CPU server node 308 may not be sufficient for all of the operations intended to be performed by the CPU server node 308. Instead, a large pool of high-speed or specialized memory may be dynamically provisioned between a number of nodes, so that the nodes have access to a large pool of resources, but those resources do not sit idle when that particular node does not need them. A distributed architecture of this type is possible due to the high speeds and low latencies provided by the fabric 370 of contemporary datacenters and may be advantageous because there is no need to over-provision resources for the server nodes.

The memory server node 304 can include memory nodes 305 having memory technologies that are suitable for the storage of data used during the execution of program code by the heterogenous compute server node 306 and the CPU server node 308. The memory nodes 305 can include volatile memory modules, such as DRAM modules, and/or non-volatile memory technologies that can operate similar to DRAM speeds, such that those modules have sufficient throughput and latency performance metrics to be used as a tier of system memory at execution runtime. The memory server node 304 can be linked with the heterogenous compute server node 306 and/or CPU server node 308 via technologies such as CXL.mem, which enables memory access from a host to a device. In such configuration, a CPU 319 of the heterogenous compute server node 306, a CPU server node 308 can link to the memory server node 304 and access the memory nodes 305 of the memory server node 304 in a similar manner as, for example, the CPU 319 of the heterogenous compute server node 306 can access device memory of a GPU within the heterogenous compute server node 306. For example, the memory server node 304 may provide remote direct memory access (RDMA) to the memory nodes 305, in which, for example, the CPU server node 308 may access memory resources on the memory server node 304 via the fabric 370 using direct memory access (DMA) operations, in a similar manner as how the CPU would access its own onboard memory.

The memory server node 304 can be used by the heterogenous compute server node 306 and CPU server node 308 to expand the runtime memory that is available during memory-intensive activities such as the training of machine learning models. A tiered memory system can be enabled in which model data can be swapped into and out of the memory devices 318 of the heterogenous compute server node 306 to memory of the memory server node 304 at higher performance and/or lower latency than local storage (e.g., storage devices 316). During workload execution setup, the entire working set of data may be loaded into one or more of the memory nodes 305 of the memory server node 304 and loaded into the memory devices 318 of the heterogenous compute server node 306 as needed during execution of a heterogenous workload.

The storage server node 310 provides storage functionality to the heterogenous compute server node 306, the CPU server node 308, and potentially the memory server node 304. The storage server node 310 may provide a networked bunch of disks or just a bunch of disks (JBOD), program flash memory (PFM), redundant array of independent disks (RAID), redundant array of independent nodes (RAIN), network attached storage (NAS), or other nonvolatile memory solutions. In one configuration, the storage server node 310 can couple with the heterogenous compute server node 306, the CPU server node 308, and/or the memory server node 304 such as NVMe-oF, which enables the NVME protocol to be implemented over the fabric 370. In such configurations, the fabric interface 372 of those servers may be smart interfaces that include hardware to accelerate NVMe-oF operations.

The accelerators 330 within the datacenter 300 can provide various accelerated functions, including hardware or coprocessor acceleration for functions such as packet processing, encryption, decryption, compression, decompression, network security, or other accelerated functions in the datacenter. In some examples, accelerators 330 may include deep learning accelerators, such as neural processing units (NPU), that can receive offload of matrix multiply operations of other neural network operations from the heterogenous compute server node 306 or the CPU server node 308. In some configurations, the accelerators 330 may reside in a dedicated accelerator server or distributed throughout the various server nodes of the datacenter 300. For example, an NPU may be directly attached to one or more CPU cores within the heterogenous compute server node 306 or the CPU server node 308. In some configurations, the accelerators 330 can include or be included within smart network controllers, infrastructure processing units (IPUs), or data processing units, which combine network controller functionality with accelerator, processor, or coprocessor functionality. The accelerators 330 can also include edge processing units (EPU) to perform real-time inference operations at the edge of the network.

In one configuration, the datacenter 300 can include gateways 340A-340B from the fabric 370 to other fabrics, fabric architectures, or interconnect technologies. For example, where the fabric 370 is an InfiniBand fabric, the gateways 340A-340B may be gateways to an Ethernet fabric. Where the fabric 370 is an Ethernet fabric, the gateways 340A-340B may include routers to route data to other portions of the datacenter 300 or to a larger network, such as the Internet. For example, a first gateway 340A may connect to a different network or subnet within the datacenter 300, while a second gateway 340B may be a router to the Internet.

The orchestrator 360 manages the provisioning, configuration, and operation of network resources within the datacenter 300. The orchestrator 360 may include hardware or software that executes on a dedicated orchestration server. The orchestrator 360 may also be embodied within software that executes, for example, on the CPU server node 308 that configures software defined networking (SDN) functionality of components within the datacenter 300. In various configurations, the orchestrator 360 can enable automated provisioning and configuration of components of the datacenter 300 by performing network resource allocation and template-based deployment. Template-based deployment is a method for provisioning and managing IT resources using predefined templates, where the templates may be based on standard templates required by the government, service provider, financial, standard or customer. The template may also dictate service level agreements (SLA) or service level obligations (SLO). The orchestrator 360 can also perform functionality including but not limited to load balancing and traffic engineering, network segmentation, security automation, real-time telemetry monitoring, and adaptive switching management, including telemetry-based adaptive switching. In some configurations, the orchestrator 360 can also provide multi-tenancy and virtualization support by enabling virtual network management, including the creation and deletion of virtual LANs (VLANs) and virtual private networks (VPNs), and tenant isolation for multi-tenant datacenters.

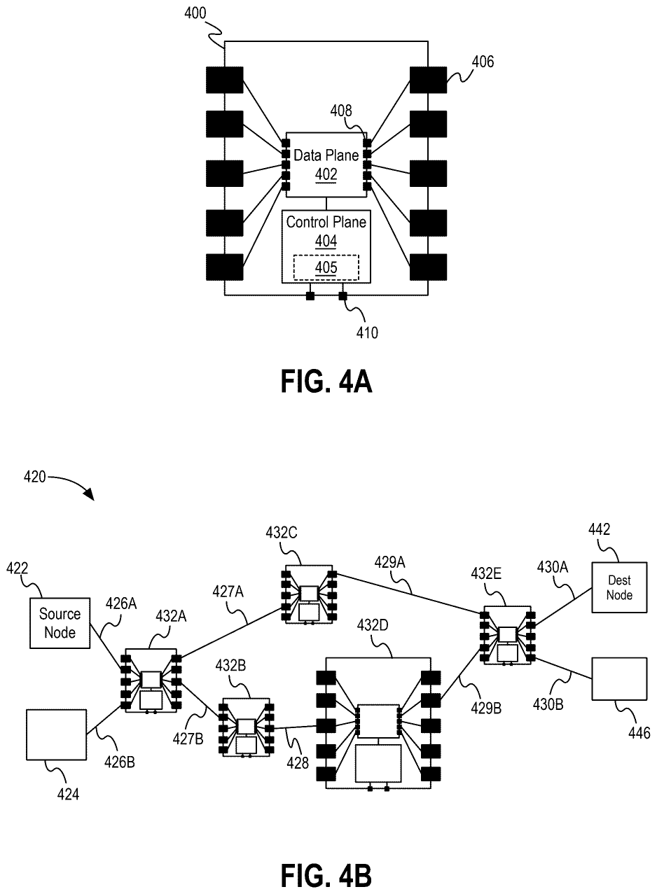

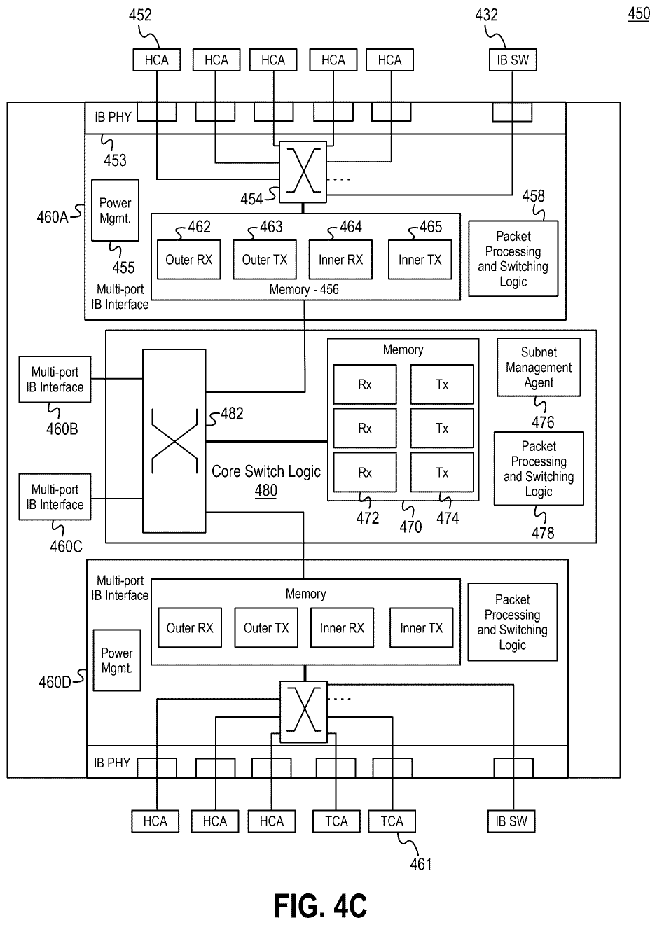

FIG. 4A-4C illustrates programmable forwarding elements and adaptive routing. FIG. 4A illustrates a forwarding element that includes a control plane and a programmable data plane. FIG. 4B illustrates a network having switching devices configured to perform adaptive routing and telemetry-based congestion control. FIG. 4C illustrates an InfiniBand switch including multi-port IB interfaces.

FIG. 4A shows a forwarding element 400 that can be configured to forward data messages within a network based on a program provided by a user. The program, in some embodiments, includes instructions for forwarding data messages, as well as performing other processes such as firewall, denial of service attack protection, and load balancing operations. The forwarding element 400 can be any type of forwarding element, including but not limited to a switch, a router, or a bridge. The forwarding element 400 can forward data messages associated with various technologies, such as but not limited to Ethernet, Ultra Ethernet, InfiniBand, or NVLink.

In various network configurations, the forwarding element is deployed as a non-edge forwarding element in the interior of the network to forward data messages from a source device to a destination device. In network configurations, the forwarding element 400 is deployed as an edge forwarding element at the edge of the network to connect to compute devices (e.g., standalone or host computers) that serve as sources and destinations of the data messages. As a non-edge forwarding element, the forwarding element 400 forwards data messages between forwarding elements in the network, such as through an intervening network fabric. As an edge forwarding element, the forwarding element 400 forwards data messages to and from edge compute devices, to other edge forwarding elements and/or to non-edge forwarding elements.

The forwarding element 400 includes circuitry to implement a data plane 402 that performs the forwarding operations of the forwarding element 400 to forward data messages received by the forwarding element to other devices. The forwarding element 400 also includes circuitry to implement a control plane 404 that configures the data plane circuit. Additionally, the forwarding element 400 includes physical ports 406 that receive data messages from, and transmit data messages to, devices outside of the forwarding element 400. The data plane 402 includes ports 408 that receive data messages from the physical ports 406 for processing. The data messages are processed and forwarded to another port on the data plane 402, which is connected to another physical port of the forwarding element 400. In addition to being associated with physical ports of the forwarding element 400, some of the ports 408 on the data plane 402 may be associated with other modules of the data plane 402.

The data plane includes programmable packet processor circuits that provide several programmable message-processing stages that can be configured to perform the data-plane forwarding operations of the forwarding element 400 to process and forward data messages to their destinations. These message-processing stages perform these forwarding operations by processing data tuples (e.g., message headers) associated with data messages received by the data plane 402 in order to determine how to forward the messages. The message-processing stages include match-action units (MAUs) that try to match data tuples (e.g., header vectors) of messages with table records that specify action to perform on the data tuples. In some embodiments, table records are populated by the control plane 404 and are not known when configuring the data plane to execute a program provided by a network user. The programmable message-processing circuits are grouped into multiple message-processing pipelines. The message-processing pipelines can be ingress or egress pipelines before or after the forwarding element's traffic management stage that directs messages from the ingress pipelines to egress pipelines.

The specifics of the hardware of the data plane 402 depends on the communication protocol implemented via the forwarding element 400. Ethernet switches use application specific integrated circuits (ASICs) designed to handle Ethernet frames and the TCP/IP protocol stack. These ASICs are optimized for a broad range of traffic types, including unicast, multicast, and broadcast. Ethernet switch ASICs are generally designed to balance cost, power consumption, and performance, although high-end Ethernet switches may support more advanced features such as deep packet inspection and advanced QoS (Quality of Service). InfiniBand switches use specialized ASICs designed for ultra-low latency and high throughput. These ASICs enable features such as optimized for handling the InfiniBand protocol and provide support for RDMA and other features that require precise timing and high-speed data processing, although high-end Ethernet switches may support RoCE (RDMA over Converged Ethernet), which offers similar benefits to InfiniBand but with higher latency compared to native InfiniBand RDMA.

The forwarding element 400 may also be configured as an NVLink switch (e.g., NVSwitch), which is used to interconnect multiple graphics processors via the NVLink connection protocol. When configured as an NVLink switch, the forwarding element 400 can provide GPU servers with increased GPU to GPU bandwidth relative to GPU servers interconnected via InfiniBand. An NVLink switch can reduce network traffic hotspots that may occur when interconnected GPU-equipped servers execute operations such as distributed neural network training.

In general, where the data plane 402, in concert with a program executed on the data plane 402 (e.g., a program written in the P4 language), performs message or packet forwarding operations for incoming data, the control plane 404 determines how messages or packets should be forwarded. The behavior of a program executed on the data plane 402 is determined in part by the control plane 404, which populates match-action tables with specific forwarding rules. The forwarding rules that are used by the program executed on the data plane 402 are independent of the data plane program itself. In one configuration, the control plane can couple with a management port 410 that enables administrator configuration of the forwarding element 400. The data connection that is established via the management port 410 is separate from the data connections for ingress and egress data ports. In one configuration, the management ports 410 may connect with a management plane 405, which facilitates administrative access to the device, enables the analysis of device state and health, and enables device reconfiguration. The management plane 405 may be a portion of the control plane 404 or in direct communication with the control plane 404. In one implementation, there is no direct access for the administrator to components of the control plane 404. Instead, information is gathered by the management plane 405 and the changes to the control plane 404 are carried out by the management plane 405.

FIG. 4B shows a network 420 having switches 432A-432E with support for adaptive routing and telemetry-based congestion control. The network 420 can be implemented using a variety of communication protocols described herein. In one embodiment, the network 420 is implemented using the InfiniBand protocol. In one embodiment, the network 420 is an Ethernet, converged Ethernet, or Ultra Ethernet network. The network 420 may include aspects of the fabric 370 of FIG. 3. The switches 432A-432E may be an implementation of the forwarding element 400 of FIG. 4A. The network 420 provides packet-based communication for multiple nodes (e.g., node 424, node 446), including a source node 422 and a destination node 442 of a data transfer to be performed over the network 420. Packets of a flow are forwarded over a route through the network 420 that traverses the switches (switch 432A-432E) and links (link 426A-426B, 427A-427B, 428, 429A-429B, 430A-430B) of the network 420. In an InfiniBand application, the switches and links belong to a certain InfiniBand subnet that is managed by a Subnet Manager (SM), which may be included within one of the switches (e.g., switch 432D). The source node 422 and the destination node 442 are the source and destination nodes for an exemplary dataflow. Depending on the configuration of the network 420, packets may flow from any node to any other node via one or more paths.

The switches 432A-432E include a data plane 402, a control plane 404, a management plane 405, and physical ports 406, as in the forwarding element 400 of FIG. 4A. A processor of the control plane 404 can be used to implement adaptive routing techniques to adjust a route between the source node 422 and the destination node 442 based on the current state of the network. During network operation, the route from the source node 422 to the destination node 442 may at some point become unsuitable or compromised in its ability to transfer packets due to various events, such as congestion, link fault, or head-of-line blocking. Should such scenario occur, the switched 432A-432E can be configured to dynamically adapt the route of the packets that flow along a compromised path.

An adaptive routing (AR) event may be detected by one of the switches along a route that becomes compromised, for example, when the switch when it attempts to output packets on a designated output port. For example, an exemplary data from the source node 422 to the destination node 442 can traverse links through switches of the network. An AR event may be detected by switch 432D for link 429B, for example, in response to congestion or a link fault associated with link 429B. Upon detecting the AR event, switch 432D, as the detecting switch, generates an adaptive routing notification (ARN), which has an identifier that distinguishes an ARN packet from other packet types. In various embodiments, the ARN includes parameters such as an identifier for the detecting switch, the type of AR event, and the source and destination address of the flow that triggered the AR event, and/or any other suitable parameters. The detecting switch sends the ARN backwards along the route to the preceding switches. The ARN may include a request for notified switches to modify the route to avoid traversal of the detected switch. A notified switch can then evaluate whether its routes may be modified to bypass the detecting switch. Otherwise, the switch forwards the ARN to the previous preceding switch along the route. In this scenario, switch 432B is not able to avoid switch 432D and will relay the ARN to switch 432A. Switch 432A can determine to adapt the route to the destination node 442 by using link 427A to switch 432C. Switch 432C can reach switch 432E via link 429A, allowing packets from the source node 422 to reach the destination node 442 while bypassing the AR event related to link 429B.

In various configurations, the network 420 can also adapt to congestion scenarios via programmable data planes within the switches 432A-432E that are able to execute data plane programs to implement in-network congestion control algorithms (CCAs) for TCP over Ethernet-based fabrics. Using in-band network telemetry (INT), programmable data planes within the switches 432A-432E can become aware when a port or link along a route is becoming congested and preemptively seek to route packets over alternate paths. For example, switch 432A can load balance traffic to the destination node 442 between link 427A and link 427B based on the level of congestion seen on the routes downstream from those links.

FIG. 4C shows an InfiniBand switch 450, which may be an implementation of the forwarding element 400 of FIG. 4A. The InfiniBand switch 450 includes a programmable data plane and is configurable to perform adaptive routing and telemetry-based congestion control as described herein. The InfiniBand switch 450 includes multi-port IB interfaces 460A-460D and core switch logic 480. The multi-port IB interfaces 460A-460D include multiple ports. In one embodiment, a single instance of a physical interface (IB PHY 453) is present, with input and output buffers associated with a port. In one embodiment, ports have a separate physical interfaces. The ports can couple with, for example, an HCA 452, a TCA 461, or another InfiniBand switch 432. The multi-port IB interfaces 460A-460D can include a crossbar switch 454 that is configured to selectively couple input and output port buffers to local memory 456. The crossbar switch 454 is a non-blocking crossbar switch that provides direct and low latency switching with a fixed or variable packet size.

The local memory 456 includes multiple queues, including an outer receive queue 462, an outer transmit queue 463, an inner receive queue 464, and an inner transmit queue 465. The outer queues are used for data that is received at a given multi-port IB interface that is to be forwarded back out the same multi-port IB interface. The inner queues are used for data that is forwarded out a different multi-port IB interface than used to receive the data. Other types of queue configurations may be implemented in local memory 456. For example, different queues may be present to support multiple traffic classes, either on an individual port basis, shared port basis, or a combination thereof. The multi-port IB interfaces 460A-460D includes power management circuitry 455, which can adjust a power state of circuitry within the respective multi-port IB interface. Additionally power management logic that performs similar operations may be implemented as part of core switch logic.

The multi-port IB interfaces 460A-460D include packet processing and switching logic 458, which is generally used to perform aspects of packet processing and/or switching operations that are performed at the local multi-port level rather than across the IB switch as a whole. Depending on the implementation, the packet processing and switching logic 458 can be configured to perform a subset of the operations of the packet processing and switching logic 478 within the core switch logic 480, or can be configured with the full functionality of the packet processing and switching logic 478 within the core switch logic 480. The processing functionality of the packet processing and switching logic 458 may vary, depending on the complexity of the operations and/or speed the operations are to be performed. For example, the packet processing and switching logic 458 can include processors ranging from microcontrollers to multi-core processors. A variety of types or architectures of multi-core processors may also be used. Additionally, a portion of the packet processing operations may be implemented by embedded hardware logic.

The core switch logic 480 includes a crossbar 482, memory 470, a subnet management agent (SMA 476), and packet processing and switching logic 478. The crossbar 482 is a non-blocking low latency crossbar that interconnects the multi-port IB interfaces 460A-460D and connects with the memory 470. The memory 470 includes receive queues 472 and transmit queues 474. In one embodiment, packets to be switched between the multi-port IB interfaces 460A-460D can be received by the crossbar 482, stored in one of the receive queues 472, processed by the packet processing and switching logic 478, and stored in a transmit queues 474 for transmission to the outbound multi-port IB interface. In implementations that do not use the multi-port IB interfaces 460A-460D, the core switch logic 480 and crossbar 482 switches packets directly between I/O buffers with the receive queues 472 and transmit queues 474 within the memory 470.

The packet processing and switching logic 478 includes programmable functionality and can execute data plane programs via a variety of types or architectures of multi-core processors. The packet processing and switching logic 478 is representative of the applicable circuitry and logic for implementing switching operations, as well as packet processing operations beyond which may be performed at the ports themselves. Processing elements of the packet processing and switching logic 478 executes software and/or firmware instructions configured to implement packet processing and switch operations. Such software and/or firmware may be stored in non-volatile storage on the switch itself. The software may also be downloaded or updated over a network in conjunction with initializing operations of the InfiniBand switch 450.

The SMA 476 is configurable to manage, monitor, and control functionality of the InfiniBand switch 450. The SMA 476 is also an agent of and in communication of the subnet manager (SM) for the subnet associated with the InfiniBand switch 450. The SM is the entity that discovers the devices within the subnet and performs a periodic sweep of the subnet to detect changes to the subnet's topology. One SMA within a subnet can be elected the primary SMA for the subnet and act as the SM. Other SMAs within the subnet will then communicate with that SMA. Alternatively, the SMA 476 can operate with other SMAs in the subnet to act as a distributed SM. In some embodiments, SMA 476 includes or executes on standalone circuitry and logic, such as a microcontroller, single core processor, or multi-core processor. In other embodiments, SMA 476 is implemented via software and/or firmware instructions executed on a processor core or other processing element that is part of a processor or other processing element used to implement packet processing and switching logic 478.

Embodiments are not specifically limited to implementations including multi-port IB interfaces 460A-460D. In one embodiment, ports are associated with their own receive and transmit buffers, with the crossbar 482 being configured to interconnect those buffers with receive queues 472 and transmit queues 474 in the memory 470. Packet processing and switching is then primarily performed by the packet processing and switching logic 478 of the core switch logic 480.

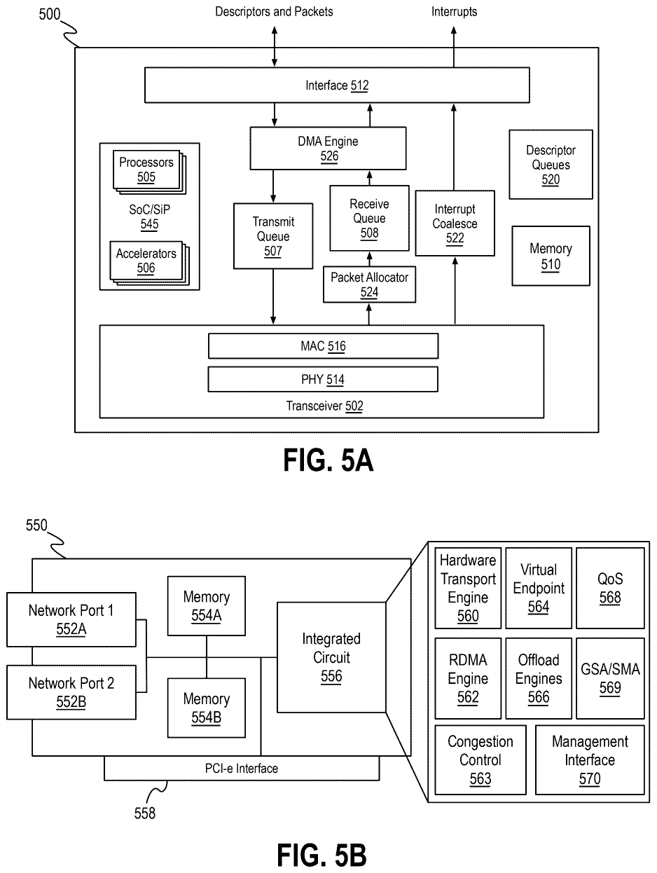

FIG. 5A-5B depict example network interface devices. FIG. 5A illustrates a network interface device 500 that may be configured as a smart Ethernet device. FIG. 5B illustrates a network interface device 550 which may be configured as an InfiniBand channel adapter.

As shown in FIG. 5A, in one configuration, the network interface device 500 can include a transceiver 502, transmit queue 507, receive queue 508, memory 510, and bus interface 512, and DMA engine 526. The network interface device 500 can also include an SoC/SiP 545, which includes processors 505 to implement smart network interface device functionality, as well as accelerators 506 for various accelerated functionality, such as NVMe-oF or RDMA. The specific makeup of the network interface device 500 depends on the protocol implemented via the network interface device 500.

In various configurations, the network interface device 500 is configurable to interface with networks including but not limited to Ethernet, including Ultra Ethernet. However, the network interface device 500 may also be configured as an InfiniBand or NVLink interface via the modification of various components. For example, the transceiver 502 can be capable of receiving and transmitting packets in conformance with the InfiniBand, Ethernet, or NVLink protocols. Other protocols may also be used. The transceiver 502 can receive and transmit packets from and to a network via a network medium. The transceiver 502 can include PHY circuitry 514 and media access control circuitry (MAC circuitry 516). PHY circuitry 514 can include encoding and decoding circuitry to encode and decode data packets according to applicable physical layer specifications or standards. MAC circuitry 516 can be configured to assemble data to be transmitted into packets, that include destination and source addresses along with network control information and error detection hash values.

The SoC/SiP 545 can include processors that may be any a combination of a CPU processor, graphics processing unit (GPU), field programmable gate array (FPGA), application specific integrated circuit (ASIC), or other programmable hardware device that allow programming of network interface device 500. For example, a smart network interface can provide packet processing capabilities in the network interface using processors 505. Configuration of operation of processors 505, including programmable data plane processors, can be programmed using Programming Protocol-independent Packet Processors (P4), C, Python, Broadcom Network Programming Language (NPL), x86, or ARM compatible executable binaries or other executable binaries.

The packet allocator 524 can provide distribution of received packets for processing by multiple CPUs or cores using timeslot allocation. An interrupt coalesce circuit 522 can perform interrupt moderation in which the interrupt coalesce circuit 522 waits for multiple packets to arrive, or for a time-out to expire, before generating an interrupt to host system to process received packet(s). Receive Segment Coalescing (RSC) can be performed by the network interface device 500 in which portions of incoming packets are combined into segments of a packet. The network interface device 500 can then provide this coalesced packet to an application. A DMA engine 526 can copy a packet header, packet payload, and/or descriptor directly from host memory to the network interface or vice versa, instead of copying the packet to an intermediate buffer at the host and then using another copy operation from the intermediate buffer to the destination buffer. The memory 510 can be any type of volatile or non-volatile memory device and can store any queue or instructions used to program the network interface device 500. The transmit queue 507 can include data or references to data for transmission by network interface. The receive queue 508 can include data or references to data that was received by network interface from a network. The descriptor queues 520 can include descriptors that reference data or packets in transmit queue 507 or receive queue 508. The bus interface 512 can provide an interface with host device. For example, the bus interface 512 can be compatible with PCI Express, although other interconnection standards may be used.

As shown in FIG. 5B, a network interface device 550 can be configured as an implementation of the network interface device 500 to implement an InfiniBand HCA. The network interface device 550 includes network ports 552A-552B, memory 554A-554B, a PCIe interface 558 and an integrated circuit 556 that includes hardware, firmware, and/or software to implement, manage, and/or control HCA functionality. In one implementation, the integrated circuit includes a hardware transport engine 560, an RDMA engine 562, congestion control logic 563, virtual endpoint logic 564, offload engines 566, QoS logic 568, GSA/SMA logic 569, and a management interface. Different implementations of the network interface device 550 may include additional components or may exclude some components. A network interface device 550 configured as a TCA will include some implementation specific subset of the functionality of an HCA. The integrated circuit 556 includes programmable and fixed function hardware to implement the described functionality.

While the illustrated implementation of the network interface device 550 is shown as having a PCIe interface 558, other implementations can use other interfaces. For example, the network interface device 550 may use an Open Compute Project (OCP) mezzanine connector. Additionally, the PCIe interface 558 may also be configured with a multi-host solution that enables multiple compute or storage hosts to couple with the network interface device 550. The PCIe interface 558 may also support technology that enables direct PCIe access to multiple CPU sockets, which eliminates the need for network traffic to traverse the inter-processor bus of a multi-socket server motherboard for a server that includes the network interface device 550.

The network interface device 550 implements endpoint elements of the InfiniBand architecture, which is based around queue pairs and RDMA. InfiniBand off-loads traffic control from software through the use of execution queues (e.g., work queues), which are initiated by a software client and managed in hardware. Communication endpoints includes a queue pair (QP) having a send queue and a receive queue. A QP is a memory-based abstraction where communication is achieved between memory-to-memory transfers between applications or between applications and devices. Communication to QPs occurs through virtual lanes of the network ports 552A-552B, which enable multiple independent data flows to share the same link, with separate buffering and flow control for respective flows.

Communication occurs via channel I/O, in which a virtual channel directly connects two applications that exist in separate address spaces. The hardware transport engine 560 includes hardware logic to perform transport level operations via the QP for an endpoint. The RDMA engine 562 leverages the hardware transport engine 560 to perform RDMA operations between endpoints. The RDMA engine 562 implements RDMA operations in hardware and enables an application to read and write the memory of a remote system without OS kernel intervention or unnecessary data copies by allowing one endpoint of a communication channel to place information directly into the memory of another endpoint. The virtual endpoint logic 564 manages the operation of a virtual endpoint for channel I/O, which is a virtual instance of a QP that will be used by an application. The virtual endpoint logic 564 maps the QPs into the virtual address space of an application associated with a virtual endpoint.

Congestion control logic 563 performs operations to mitigate the occurrence of congestion on a channel. In various implementations, the congestion control logic 563 can perform flow control over a channel to limit congestion at the destination of a data transfer. The congestion control logic 563 can perform link level flow control to manage congestion at source congestion at virtual links of the network ports 552A-552B. In some implementations, the congestion control logic can perform operations to limit congestion at intermediate points (e.g., IB switches) along a channel.

Offload engines 566 enable the offload of network tasks that may otherwise be performed in software to the network interface device 550. The offload engines 566 can support offload of operations including but not limited to offload of receive side scaling from a device driver or stateless network operations, for example, for TCP implementations over InfiniBand, such as TCP/UDP/IP stateless offload or Virtual Extensible Local Area Network (VXLAN) offload. The offload engines 566 can also implement operations of a interrupt coalesce circuit 522 of the network interface device 500 of FIG. 5A. The offload engines 566 can also be configured to support offload of NVME-oF or other storage acceleration operations from a CPU.

The QoS logic 568 can perform QoS operations, including QoS functionality that is inherent within the basic service delivery mechanism of InfiniBand. The QoS logic 568 can also implement enhanced InfiniBand QoS, such as fine grained end-to-end QoS. The QoS logic 568 can implement queuing services and management for prioritizing flows and guaranteeing service levels or bandwidth according to flow priority. For example, the QoS logic 568 can configure virtual lane arbitration for virtual lanes of the network ports 552A-552B according to flow priority. The QoS logic 568 can also operate in concert with the congestion control logic 563.

The GSA/SMA logic 569 implements general services agent (GSA) operations to manage the network interface device 550 and the InfiniBand fabric, as well as performing subnet management agent operations. The GSA operations include device-specific management tasks, such as querying device attributes, configuring device settings, and controlling device behavior. The GSA/SMA logic 569 can also implement SMA operations, including a subset of the operations performed by the SMA 476 of the InfiniBand switch 450 of FIG. 4C. For example, the GSA/SMA logic 569 can handle management requests from the subnet manager, including device reset requests, firmware update requests, or requests to modify configuration parameters.

The management interface 570 provides support for a hardware interface to perform out-of-band management of the network interface device 550, such as an interconnect to a board management controller (BMC) or a hardware debug interface.

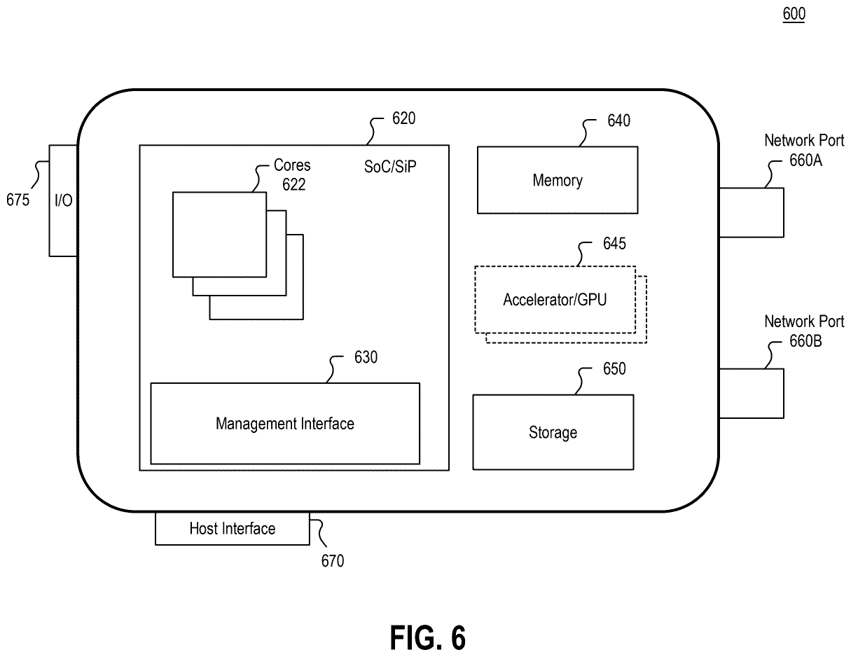

FIG. 6 is a block diagram illustrating a programmable network interface 600 and data processing unit. The programmable network interface 600 is a programmable network engine that can be used to accelerate network-based compute tasks within a distributed environment. The programmable network interface 600 can couple with a host system via host interface 670. The programmable network interface 600 can be used to accelerate network or storage operations for CPUs or GPUs of the host system. The host system can be, for example, a node of a distributed learning system used to perform distributed training, for example, as shown in FIG. 6. The host system can also be a data center node within a data center.

In one embodiment, access to remote storage containing model data can be accelerated by the programmable network interface 600. For example, the programmable network interface 600 can be configured to present remote storage devices as local storage devices to the host system. The programmable network interface 600 can also accelerate RDMA operations performed between GPUs of the host system with GPUs of remote systems. In one embodiment, the programmable network interface 600 can enable storage functionality such as, but not limited to NVME-OF. The programmable network interface 600 can also accelerate encryption, data integrity, compression, and other operations for remote storage on behalf of the host system, allowing remote storage to approach the latencies of storage devices that are directly attached to the host system.

The programmable network interface 600 can also perform resource allocation and management on behalf of the host system. Storage security operations can be offloaded to the programmable network interface 600 and performed in concert with the allocation and management of remote storage resources. Network-based operations to manage access to the remote storage that would otherwise by performed by a processor of the host system can instead be performed by the programmable network interface 600.

In one embodiment, network and/or data security operations can be offloaded from the host system to the programmable network interface 600. Data center security policies for a data center node can be handled by the programmable network interface 600 instead of the processors of the host system. For example, the programmable network interface 600 can detect and mitigate against an attempted network-based attack (e.g., DDoS) on the host system, preventing the attack from compromising the availability of the host system.

The programmable network interface 600 can include a system on a chip (SoC/SiP 620) that executes an operating system via multiple processor cores 622. The processor cores 622 can include general-purpose processor (e.g., CPU) cores. In one embodiment the processor cores 622 can also include one or more GPU cores. The SoC/SiP 620 can execute instructions stored in a memory device 640. A storage device 650 can store local operating system data. The storage device 650 and memory device 640 can also be used to cache remote data for the host system. Network ports 660A-660B enable a connection to a network or fabric and facilitate network access for the SoC/SiP 620 and, via the host interface 670, for the host system. In one configuration, a first network port 660A can connect to a first forwarding element, while a second network port 660B can connect to a second forwarding element. Alternatively, both network ports 660A-660B can be connected to a single forwarding element using a link aggregation protocol (LAG). The programmable network interface 600 can also include an I/O interface 675, such as a Universal Serial Bus (USB) interface. The I/O interface 675 can be used to couple external devices to the programmable network interface 600 or as a debug interface. The programmable network interface 600 also includes a management interface 630 that enables software on the host device to manage and configure the programmable network interface 600 and/or SoC/SiP 620. In one embodiment the programmable network interface 600 may also include one or more accelerators or GPUs 645 to accept offload of parallel compute tasks from the SoC/SiP 620, host system, or remote systems coupled via the network ports 660A-660B. For example, the programmable network interface 600 can be configured with a graphics processor and participate in general-purpose or graphics compute operations in a datacenter environment.

One or more aspects may be implemented by representative code stored on a machine-readable medium which represents and/or defines logic within an integrated circuit such as a processor. For example, the machine-readable medium may include instructions which represent various logic within the processor. When read by a machine, the instructions may cause the machine to fabricate the logic to perform the techniques described herein. Such representations, known as “IP cores,” are reusable units of logic for an integrated circuit that may be stored on a tangible, machine-readable medium as a hardware model that describes the structure of the integrated circuit. The hardware model may be supplied to various customers or manufacturing facilities, which load the hardware model on fabrication machines that manufacture the integrated circuit. The integrated circuit may be fabricated such that the circuit performs operations described in association with any of the embodiments described herein.

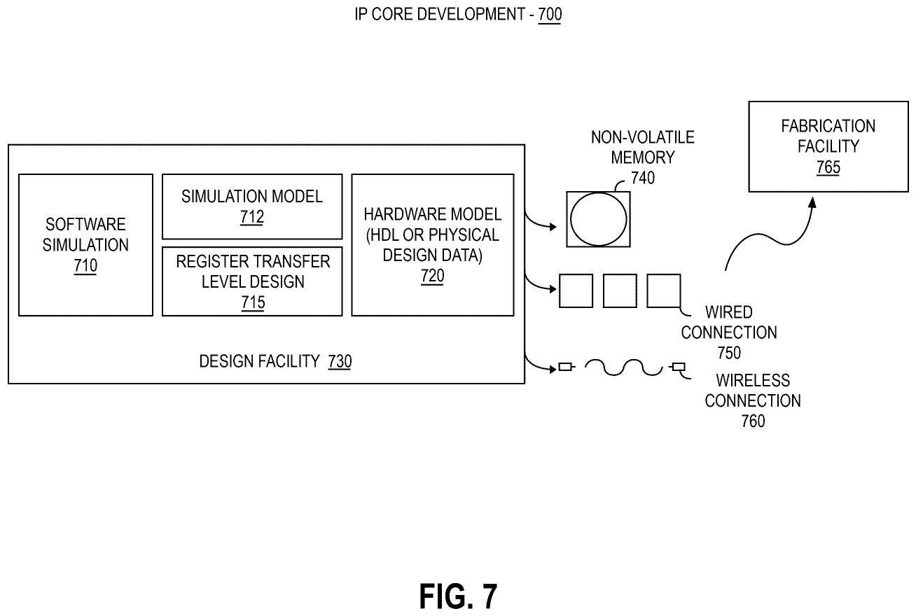

FIG. 7 is a block diagram illustrating an IP core development system 700. The IP core development system 700 may be used to manufacture an integrated circuit to perform operations of fabric and datacenter components described herein. The IP core development system 700 may be used to generate modular, re-usable designs that can be incorporated into a larger design or used to construct an entire integrated circuit (e.g., an SOC integrated circuit). A design facility 730 can generate a software simulation 710 of an IP core design in a high-level programming language (e.g., C/C++). The software simulation 710 can be used to design, test, and verify the behavior of the IP core using a simulation model 712. The simulation model 712 may include functional, behavioral, and/or timing simulations. A register transfer level design (RTL design 715) can then be created or synthesized from the simulation model 712. The RTL design 715 is an abstraction of the behavior of the integrated circuit that models the flow of digital signals between hardware registers, including the associated logic performed using the modeled digital signals. In addition to an RTL design 715, lower-level designs at the logic level or transistor level may also be created, designed, or synthesized. Thus, the particular details of the initial design and simulation may vary.

The RTL design 715 or equivalent may be further synthesized by the design facility into a hardware model 720, which may be in a hardware description language (HDL), or some other representation of physical design data. The HDL may be further simulated or tested to verify the IP core design. The IP core design can be stored for delivery to a fabrication facility 765 using non-volatile memory 740 (e.g., hard disk, flash memory, or any non-volatile storage medium). The fabrication facility 765 may be a 3rd party fabrication facility. Alternatively, the IP core design may be transmitted (e.g., via the Internet) over a wired connection 750 or wireless connection 760. The fabrication facility 765 may then fabricate an integrated circuit that is based at least in part on the IP core design. The fabricated integrated circuit can be configured to perform operations in accordance with at least one embodiment described herein.

### Time Synchronization and Telemetry for Networked Devices

Network telemetry provides network operators the ability to see and understand network behavior and involves collecting and analyzing network data to gain insights into the current state of the network. Network telemetry can include data related to network interfaces, network-attached devices, and network infrastructure devices, including data related to the forwarding, control, and management planes of network infrastructure devices. Telemetry analysis software can consume and aggregate network telemetry for presentation to network operators. In some circumstances, network-attached devices and/or network infrastructure devices can be configured to take automatic or autonomous actions based on events detected within network telemetry.

Network telemetry may be in-band network telemetry (INT) or out-of-band. Out-of-band telemetry collects telemetry data separately from the regular network traffic and sends it over a dedicated or separate communication channel that is distinct from the network's primary data flow. Out-of-band telemetry is generally used in environments systems where historical (non-real-time) data collection, device health monitoring, and flow-based traffic summaries are sufficient for network management. In-band network telemetry involves collecting data from within the network, typically through network devices or agents, and can provide real-time information on network performance and traffic. In-band network telemetry collects and transmits telemetry data within the same data packets that are flowing through the network. The telemetry information can be embedded inside the headers or payloads of live traffic packets as they traverse the network. In-band network telemetry can be enabled via programable data planes including, for example, P4 programable packet processors, which can define custom in-band telemetry behaviors and can be used to embed telemetry information (e.g., latency, queue depth) into live packets as those packets traverse the network.

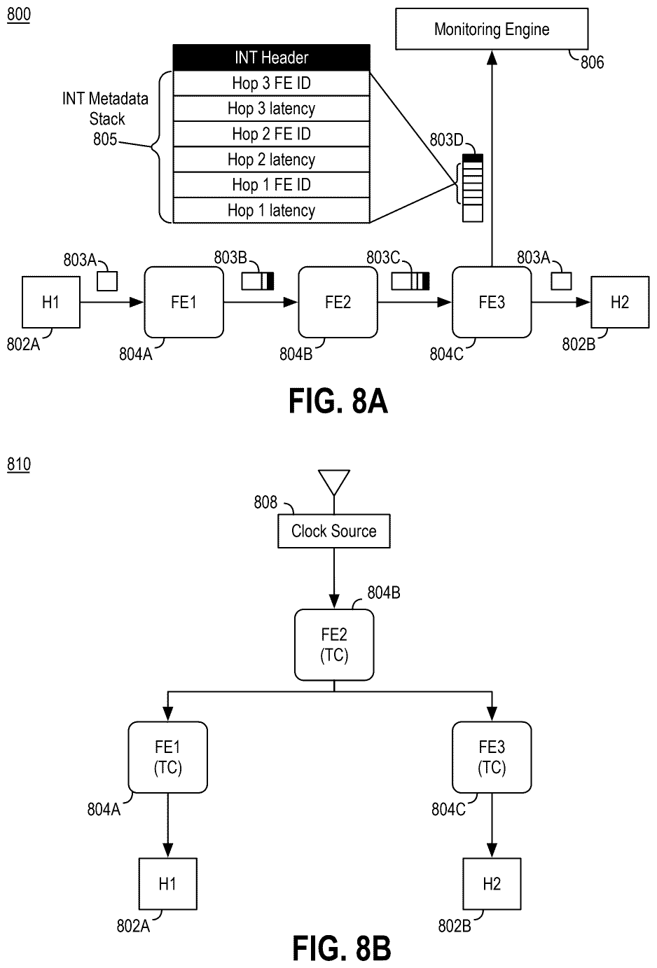

FIG. 8A-8B illustrates techniques to enable in-band network telemetry and time synchronization. FIG. 8A illustrates a system 800 that implements in-band network telemetry. FIG. 8B illustrates a system 810 that implements network-based time synchronization. Telemetry and time synchronization are related features in that the precise synchronization of timekeeping mechanisms across devices of a system enhances the precision of telemetry timestamps and latency calculations across the system.

As shown in FIG. 8A, a system 800 can enable in-band network telemetry by embedding relevant elements telemetry data within packets as those packets traverse the system 800 from a first endpoint H1 (e.g., host 802A) to a second endpoint H2 (e.g., host 802B) through multiple forwarding elements 804A-804C (FE1-FE3). The structure of the system 800 is exemplary and not limiting as to any particular embodiments described herein. The forwarding elements 804A-804C may include but are not limited to a switch, a switch chip, a router, or a bridge.

During operation, endpoint H1 can transmit a data packet 803A addressed to the second endpoint H2 to FE1 804A. FE1 804A is an INT source, which inserts an INT header and adds metadata related to its own element ID (e.g., switch ID) and forwarding delay before forwarding a data packet 803B to FE2 804B, which is an INT transit element. FE2 804B appends its own INT metadata and forwards a data packet 803C to FE3 804C. FE3 804C is an INT sink, which appends its own INT metadata and then makes a copy of the data packet 803D with all the collected INT metadata and forwards this data packet 803D to a monitoring engine 806 for analysis. As the INT sink, FE3 804C also removes the INT header and metadata to recover the original instance of the data packet 803A. FE3 804C then forwards the data packet 803A to the second endpoint H2 (host 802B).

The data packet 803D that is forwarded to the monitoring engine 806 includes an INT metadata stack 805 that includes the forward element IDs and latency for hops along the path between endpoints. The INT metadata stack 805 includes information that can be used by the monitoring engine 806 to monitor the health and performance of the network within the system 800 in real time.

Proper clock synchronization among network devices is critical for accurate data collection via INT because it ensures that the forwarding delays and timing information collected across various network devices are accurate and meaningful. Without properly synchronized clocks, the timing data would be inconsistent, leading to inaccurate latency measurements and making it difficult to correlate the timing of events across the network, particularly in high-speed networks where microsecond-level deviations can significantly impact performance and service quality.

As shown in FIG. 8B, a system 810 can implement network-based time synchronization to enable accurate INT metadata. The system 810, which may be a version of the system 800 of FIG. 8A, can implement network-based time synchronization using, for example, precision time protocol (PTP) (e.g., IEEE 1588-2002, IEEE 1588-2008, IEEE 1588-2019), or a variant thereof (e.g., IEEE 802.1AS). The system 810 can implement hierarchical clock distribution in which a clock source 808 is configured a leader and the hosts 802A-802B are configured as followers that are synchronized to the clock source 808. In one embodiment, the clock source 808 is a device with a system clock that is synchronized to a high precision clock, such as a clock associated with a global navigation satellite system (GNSS), such as but not limited to the global positioning system. The clock source 808 may also be synchronized with an atomic clock or a quantum clock source.

The clock source 808 periodically sends synchronization messages to devices within the system 810. The synchronization messages are propagated through forwarding elements 804A-804C, which are configured as transparent clocks (TC). When configured as transparent clocks, the forwarding elements 804A-804C forward the synchronization messages while modifying timestamps within the messages to account for the residence time required for event messages to traverse the forwarding elements. Some implementations configure forwarding elements 804A-804C as boundary clocks, which act as followers for upstream clocks (e.g., clock source 808) and leaders for downstream clocks (e.g., hosts 802A-802B).

When PTP synchronization messages arrive at the hosts 802A-802B, the hosts calculate the clock offset to their own clocks. The hosts 802A-802B can determine network delay by transmitting a delay request message to the clock source 808, which will send a delay response message containing the precise time the clock source 808 received the delay request message. The hosts 802A-802B can use the offset calculation and network delay to adjust their own clocks. Regular synchronization and delay messages enable the followers to keep their clocks synchronized to the clock source 808 with nanosecond precision.

### Time Synchronization for Host Interconnected Devices

Time synchronization is also useful for devices within a computing system that are interconnected by a host interconnect or other interconnect fabrics, such as PCIe or NVLink. For example, precision time measurement (PTM) is a feature that is used to enable high-precision time synchronization between devices connected via PCIe. PTM enables devices to synchronize their internal clocks with a common time reference, enabling the devices to operate in coordination at the nanosecond level. PTM operates vis message exchanges between PTM primary and secondary devices. The PTM primary device may be a PCIe root complex or PCIe switch, while the PTM secondary device is a PCIe endpoint or downstream device.

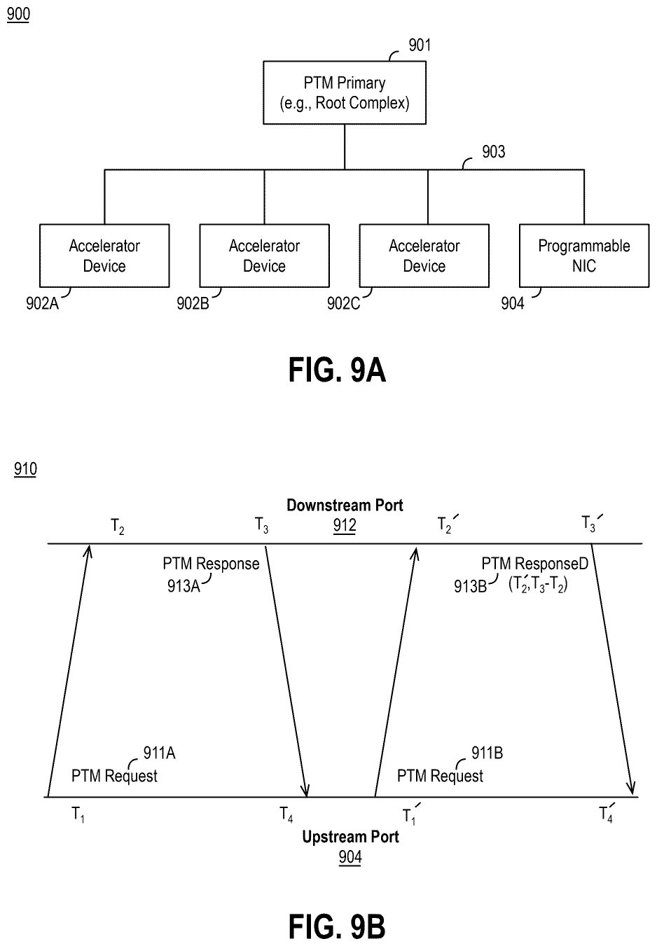

FIG. 9A-9B illustrates systems that implement precision time measurement over a host interconnect. FIG. 9A shows a system 900 in which multiple devices synchronize with a PTM primary device over the host interconnect. FIG. 9B shows a system 910 that enables PTM synchronization between upstream and downstream devices over the host interconnect.

As shown in FIG. 9A, a system 900 can synchronize independent local clocks of differing devices, which may have differing notions of the value and rate of change of time. A PTM primary 901, which may be a PCIe root complex or PCIe switch, can enable multiple downstream devices to synchronize their local clocks to the clock of the PTM primary 901. The system 900 can include, in one embodiment, multiple accelerator devices 902A-902C and a programmable network interface controller 904, which may be generators of telemetry data. The multiple accelerator devices 902A-902C and the programmable network interface controller 904 may timestamp telemetry events using local device clocks or by sampling a host clock. However, the timestamps within the telemetry generated by the multiple devices may not accurately reflect the order of events. Synchronizing the local clocks of the devices within the system 900 to a high degree of precision enables the generation of telemetry with properly synchronized timestamps, which simplifies the debugging of interrelated and/or time critical events within the system 900.

As shown in FIG. 9B, PTM operates via message exchanges between a PTM primary, which may be a PCIe root complex or PCIe switch, and PTM secondaries, which may be a PCIe endpoints or downstream devices. One PTM primary can synchronize concurrently with multiple PTM secondaries. The system clock time of the PTM primary is propagated through links in the path from the PTM primary to a PTM secondary using PTM dialogs between an upstream port 914 and a downstream port 912 at regular intervals.

A downstream device initiates a PTM dialog by sending a transaction layer packet (TLP) containing a PTM request 911A to an upstream device via the upstream port 914. The PTM request 911A is timestamped on transmit by the upstream port, which captures timestamp T₁. The downstream port 912 captures timestamp T₂ upon receipt of the PTM request 911A. The downstream port 912 responds by sending a PTM Response 913A when the PTM context does not contain any timestamps from a previously completed PTM dialog. The downstream port 912 captures timestamp T₃ when transmitting the PTM Response 913A. The upstream port 914 captures timestamp T₄ upon receipt of the PTM Response 913A. The upstream and downstream devices store the timestamps associated with the transmission and receipt of their respective messages within internal registers for use in subsequent PTM dialogs. In a second PTM dialog, the downstream device sends a PTM request 911B with timestamp T₁′ via the upstream port 914. The upstream device receives the PTM request 911B at the downstream port 912 and records timestamp T₂′. The upstream device then sends a PTM responseD 913B TLP, which contains a data payload that contains timestamp T₂′, which is the time of receipt of the most recent instance of the PTM request 911B and the propagation delay, which is the time between receipt and response for the previous PTM dialog (T₃−T₂). The downstream device receives the PTM responseD 913B TLP at time T₄′.

The downstream device can then calculate the PTM clock time, which is the system clock time of the PTM primary, based on the link delay and timestamps from the from the current and previous PTM dialogs, where:

$$Link Delay = \frac{( ( {T}_{4} - {T}_{1} ) - ( {T}_{3} - {T}_{2} ) )}{2}$$

$$PTM clock time = Downstream Clock + ( {T}_{2}^{′} - Link Delay ) - {T}_{1}^{′}$$

The downstream clock can be continuously updated via successive PTM dialogs.

### Multi-Domain Time and Telemetry Synchronization

Described herein is a system to enable coordinated time and telemetry synchronization across multiple domains via a programmable network interface. This system enables the precise coordination of events across multiple components with independent local time clocks. Ordinarily, such precise coordination would be difficult given that the devices within the system have individual time clocks with differing notions of the value and rate of change of time. While the time clocks associated with those systems may be synchronized at some level, the accuracy tasks such as distributed system event tracing and warehouse computer debugging can be improved if network-domain devices and host-domain devices are precisely synchronized to the same primary clock. This synchronization can be performed via a programmable network interface, such as a smart NIC, IPU, DPU, embedded/edge processing unit (EPU), or another type of device that is physically attached to both a high-performance network interconnect and a high-performance host interconnect.

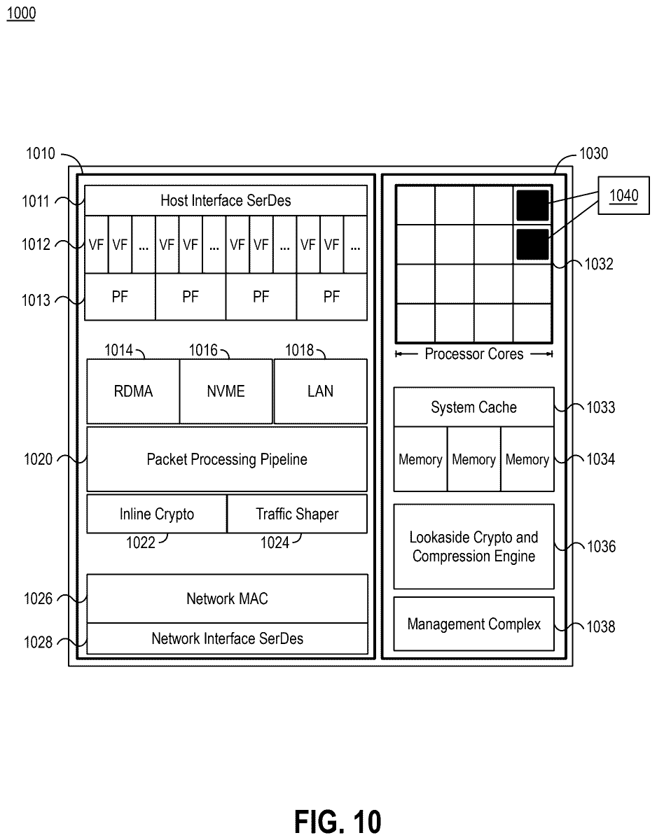

FIG. 10 illustrates a programmable network interface device 1000 that is configurable as a multi-domain time source. The programmable network interface device 1000 includes functionality of the network interface device 500 of FIG. 5A and/or the network interface device 550 of FIG. 5B and in various embodiments is configured as an Ethernet device and/or an InfiniBand device. The programmable network interface device 1000 includes a network subsystem 1010 that enables network interface functionality and a compute complex 1030 that enables program execution capability. The network subsystem 1010 includes host interface SerDes 1011 (serializer/deserializer) circuitry configurable for coupling with a host interconnect (e.g., PCIe). The network subsystem 1010 also includes a network interface SerDes 1028 circuitry and network media access control (MAC) circuitry configurable for coupling with a physical interface of a network.

The host interface SerDes 1011 couples with circuitry to provide virtual functions (VFs 1012) and physical functions (PFs 1013) for Single Root I/O Virtualization (SR-IOV) and Scalable I/O Virtualization (SIOV). Multiple instances of the PFs 1013 enable concurrent use of the programmable network interface device 1000 by multiple host processors and/or multiple physical hosts, which can virtualize the programmable network interface device 1000 via the VFs 1012 associated with the respective instances of the PFs 1013.

The programmable network interface device 1000 includes RDMA circuitry 1014 to accelerate RDMA operations and NVME circuitry 1016 to provide an NVME device interface for NVME-OF devices. LAN circuitry 1018 accelerates local area network functionality and couples with a programmable packet processing pipeline 1020, which in one embodiment is a P4 programmable pipeline. Inline cryptographic circuitry 1022 enables wire-speed packet encryption and decryption, for example, for Internet Protocol Security (IPsec) protocols and/or VPN functionality, and traffic shaper 1024 circuitry enables traffic shaping via transmit scheduling.

The compute complex 1030 includes a processor core array 1032 that can execute infrastructure software directly on the programmable network interface device 1000, enabling such functionality to be offloaded from host processors. The processor core array 1032 couples with a system cache 1033 that is backed by multiple channels of memory. A lookaside cryptographic and compression engine 1036 provides cryptographic and compression acceleration functionality to the processor core array 1032 and to host processors. Additionally, management complex circuitry 1038 includes a dedicated management processor or microcontroller that provides secure boot and life cycle management functionality and enables the remote management of the programmable network interface device 1000.

In one embodiment, the management processor within the management complex circuitry 1038 can configure the execution of multi-domain time and telemetry logic 1040 via one or more processor cores of the processor core array 1032. The multi-domain time and telemetry logic 1040 enables multi-domain time source and synchronization functionality via the programmable network interface device 1000 and can also facilitate the synchronization and aggregation of telemetry from multiple sources. The multi-domain time and telemetry logic 1040 can enable the programmable network interface device 1000 to act as a clock source to network domain devices using PTP and host domain devices using PTM or act as a relay between PTM and PTP synchronization domains. In one embodiment, the programmable network interface device 1000 can include a processor, controller, or microcontroller that is dedicated to the execution of the multi-domain time and telemetry logic 1040.

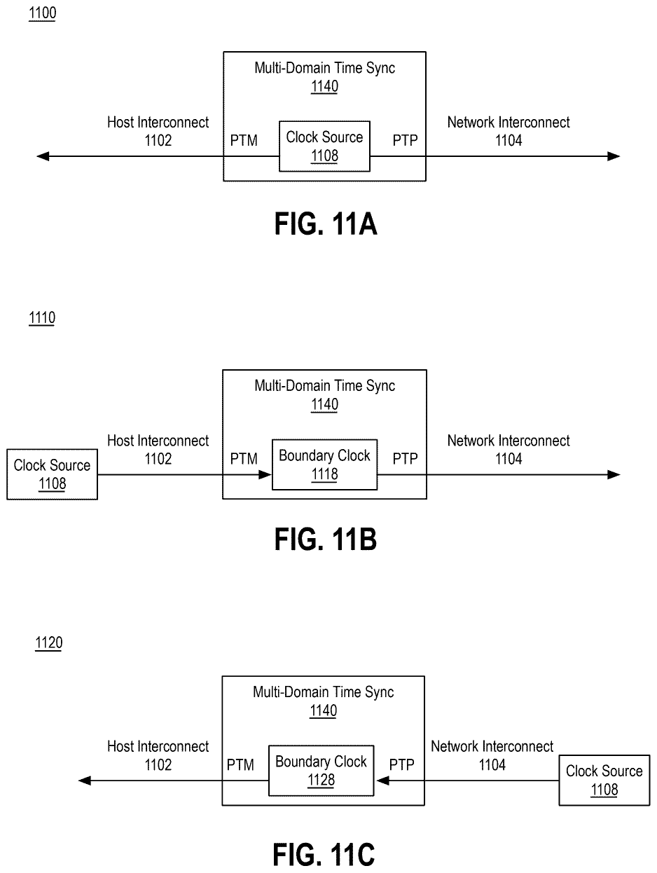

FIG. 11A-11C illustrate multi-domain time synchronization modes, according to embodiments. Multiple synchronization modes can be configured, with various embodiments supporting one, some, or all synchronization modes. The multiple synchronization modes are implemented via a multi-domain time synchronization device 1140, such as the programmable network interface device 1000 executing the multi-domain time and telemetry logic 1040 as in FIG. 10.

FIG. 11A shows a first synchronization mode 1100 in which the multi-domain time synchronization device 1140 acts as a clock source 1108 and implements PTM over a host interconnect 1102 (e.g., PCIe) and PTP over a network interconnect 1104 (e.g., Ethernet, InfiniBand). In the first synchronization mode 1100, devices on the network interconnect 1104 and devices on the host interconnect 1102 are synchronized from the clock source 1108.

FIG. 11B shows a second synchronization mode 1110 in which the multi-domain time synchronization device 1140 acts as a boundary clock 1118 to a clock source 1108 connected over the host interconnect 1102. In the second synchronization mode 1110, the multi-domain time synchronization device 1140 acts as a PTM endpoint and a PTP source. The boundary clock 1118 is synchronized via PTM from the clock source 1108. The boundary clock 1118 is then used as a PTP clock source.

FIG. 11C shows a third synchronization mode 1120 in which the multi-domain time synchronization device 1140 acts as a boundary clock 1128 to a clock source 1108 connected over the network interconnect 1104. In the third synchronization mode 1120, the multi-domain time synchronization device 1140 acts as a PTP endpoint and a PTM source. The boundary clock 1128 is synchronized via PTP and the boundary clock 1128 is then used as a PTM clock source.

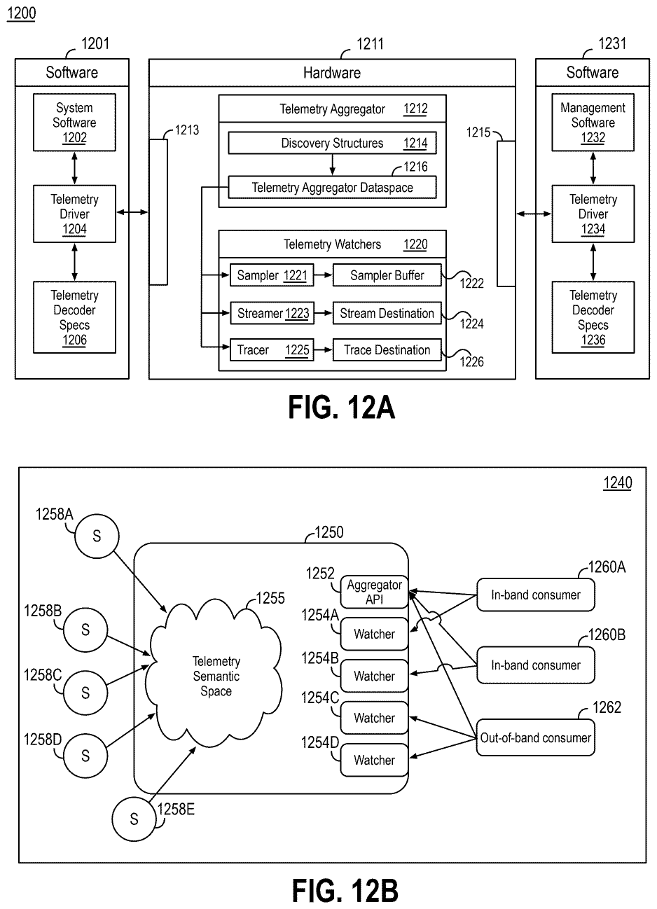

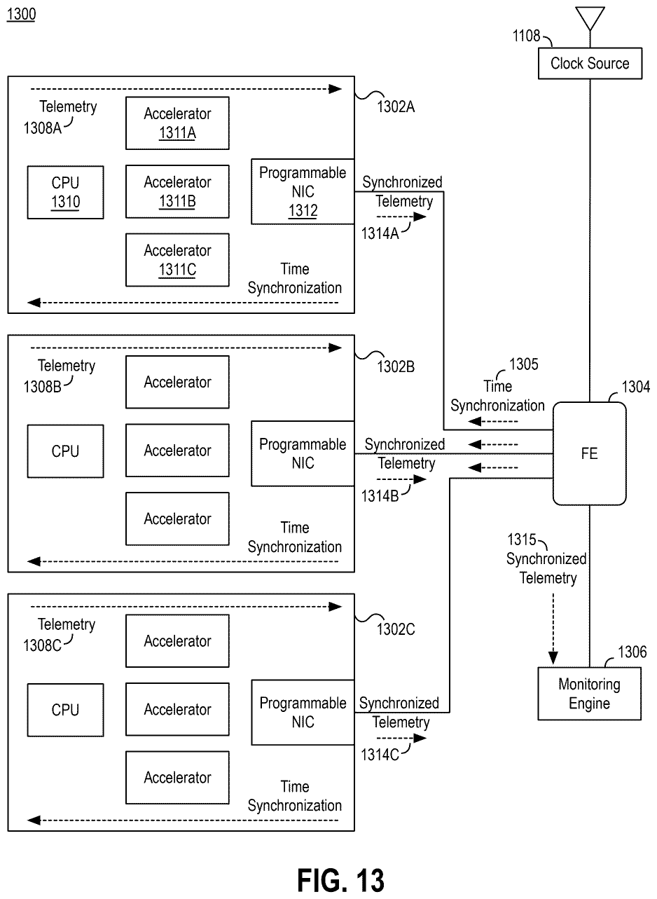

FIG. 12A-12B illustrates systems to enable multi-device telemetry aggregation, according to an embodiment. FIG. 12A illustrates an architectural overview of a telemetry system 1200. FIG. 12B illustrates components 1240 of the telemetry system 1200. The telemetry system 1200 provides support for multiple consumers and provides a standardized access mechanism that is extensible to different product segment needs. The telemetry system 1200 also provides a mechanism to discover telemetry sources using in-band and out-of-band methods.

As shown in FIG. 12A, the telemetry system includes elements of software and hardware. A first software component 1201 includes, for example, system software 1202, which interacts with a first telemetry driver 1204 that is configured to access a hardware component 1211 of the telemetry system via a first telemetry interface 1213. The first telemetry driver 1204 can reference first telemetry decoder specs 1206, which specifies the structure of received telemetry. The first telemetry interface 1213 may be an interface via a host interconnect, such as a PCIe and/or memory mapped interface. A second software component 1231 includes, for example, management software 1232 that interconnects with a second telemetry driver 1234, which references second telemetry decoder specs 1236. The second telemetry driver 1234 can access the hardware component 1211 via a second telemetry interface 1215. The second telemetry interface 1215 may be an out-of-band interface, such as a management component telemetry protocol (MCTP) and/or platform environment control interface (PECI).

The hardware component 1211 includes a telemetry aggregator 1212 and telemetry watchers 1220. The telemetry aggregator 1212 is a hardware (or firmware) agent that collects or produces telemetry for a device and then makes that telemetry available through one or more interfaces. The telemetry aggregator 1212 includes discovery structures 1214 and a telemetry aggregator dataspace 1216. The discovery structures 1214 provide a mechanism to software to identify and enumerate the monitoring capabilities that are present on a device, including the identification of the telemetry aggregator dataspace 1216. The telemetry aggregator dataspace 1216 is a memory location that stores telemetry aggregator data. The telemetry watchers 1220 provide a mechanism for a telemetry consumer to indicate to the telemetry aggregator 1212 which telemetry items to have observed, the frequency of data collection on the items, and threshold values if actions, alerts, or interrupts are to be triggered. The telemetry watchers 1220 can include a sampler 1221 that outputs to a sampler buffer 1222, a streamer 1223 that outputs to a stream destination 1224, and a tracer 1225 that outputs to a trace destination 1226.

As shown in FIG. 12B components 1240 of the telemetry system 1200 include a hardware device 1250 that represents an implementation of the hardware component 121 of FIG. 12A. The hardware device 1250 includes a telemetry semantic space 1255 that stores telemetry data received from telemetry sources 1258A-1258E. The hardware device 1250 provides an aggregator API 1252 and watchers 1254A-1254D. The aggregator API 1252 provides a mechanism for collecting telemetry information. The watchers 1254A-1254D provide a control to take actions based on a telemetry stream. In-band consumers 1260A-1260B and an out-of-band consumer 1262 of telemetry can access the aggregator API 1252 and watchers 1254A-1254D via in-band or out-of-band interfaces.

In one embodiment, the telemetry system 1200 can be configured to enable telemetry producing devices to discover and subscribe to a time synchronization protocol that is appropriate for the interface over which the device is connected. In this embodiment, participants in the telemetry system 1200 can be autoconfigured to synchronize the clock used for timestamp generation when configured as telemetry sources 1258A-1258E.

FIG. 13 illustrates a warehouse computing system 1300 with synchronized multi-domain time and telemetry, according to an embodiment. In one embodiment, the warehouse computing system 1300 uses a clock source 1108, which may be synchronized via GNSS, an atomic clock, a quantum clock, or another nanosecond precision clock. The clock source 1108 couples with a forwarding element 1304, such as a router, bridge, switch, switch chip, or virtual switch. In one embodiment the clock source 1108 acts as a primary clock source, with the forwarding element 1304 configured as a transparent clock. In one embodiment, the forwarding element 1304 acts as a primary clock and synchronizes a local clock using an in-band or out-of-band synchronization mechanism. A time synchronization stream 1305, transmitted via a time synchronization protocol, such as PTP, can be transmitted over a network (e.g., Ethernet, InfiniBand), to warehouse computer nodes 1302A-1302C. The time synchronization stream 1305 is received at a programmable NIC 1312 (e.g., Smart NIC, IPU, DPU, EPU, etc.) within the respective warehouse computer nodes 1302A-1302C.

In one embodiment, the programmable NIC 1312 of the respective warehouse computer nodes 1302A-1302C is configured to operate in the third synchronization mode 1120 shown in FIG. 11C, in which the clock source 1108 is received via the network interconnect 1104 and used to synchronize devices coupled vis the host interconnect 1102. Time synchronization messages (e.g., via PTM) are transmitted by the programmable NIC 1312 over the host interconnect to accelerators 1311A-1311C and a CPU 1310 within the respective warehouse computer nodes 1302A-1302C.

In one embodiment, using the telemetry system 1200 of FIG. 12A-12B, the programmable NIC 1312 within the respective warehouse computer nodes 1302A-1302C can aggregate telemetry 1308A-1308C generated by the CPU 1310 and/or accelerators 1311A-1311C. The telemetry 1308A-1308C includes timestamps that are synchronized to the clock source 1108 at nanosecond precision across the components of the respective warehouse computer nodes 1302A-1302C. The programmable NIC 1312 within the respective warehouse computer nodes 1302A-1302C can aggregate and synchronize the telemetry 1308A-1308C and output synchronized telemetry 1314A-1314C. The synchronized telemetry 1314A-1314C enables telemetry from the components within the respective warehouse computer nodes 1302A-1302C to be viewed in precise event order. In one embodiment, the synchronized telemetry 1314A-1314C from the respective warehouse computer nodes 1302A-1302C can be received as aggregated synchronized telemetry 1315 by a monitoring engine 1306, which may be a hardware or software component that is coupled with the respective warehouse computer nodes 1302A-1302C. In one embodiment, the monitoring engine 1306 couples with the respective warehouse computer nodes 1302A-1302C over the network via the forwarding element 1304. In one embodiment, the programmable NIC 1312 within any of the respective warehouse computer nodes 1302A-1302C may act as the monitoring engine 1306. The monitoring engine 1306 may also be a programmable NIC of a separate node of the warehouse computing system 1300.

In one embodiment, the warehouse computing system 1300 is implemented within the datacenter 300 of FIG. 3. In such embodiment, the orchestrator 360 can include a version of the programmable NIC 1312 that is configured to act as a clock source 1108 for nodes within the datacenter 300 and the fabric interface 372 associated respectively with the nodes can receive synchronization signals via a first synchronization protocol that is implemented over the fabric 370 and bridge the first synchronization protocol with a second synchronization protocol that is implemented respectively over the host interconnect of the nodes of the datacenter 300. In various embodiments, the programmable NIC 1312 can include a processor, processors, or a microcontroller that is configured to execute multi-domain time and telemetry logic 1040 as in FIG. 10 and is configured as a multi-domain time synchronization device 1140 as in FIG. 11A-11C.

In one embodiment, a single instance of the programmable NIC 1312 can be bifurcated to support multiple physical hosts via multiple physical functions (e.g., PFs 1013) or multiple virtual hosts via multiple virtual functions (VFs 1012) associated with the multiple physical functions. In such embodiment, the respective warehouse computer nodes 1302A-1302C may couple with different physical functions of the programmable NIC 1312, such that the respective warehouse computer nodes 1302A-1302C are accessible to the programmable NIC 1312 over a host interconnect, with the respective warehouse computer nodes 1302A-1302C coupled with the forwarding element 1304 via separate network interfaces.

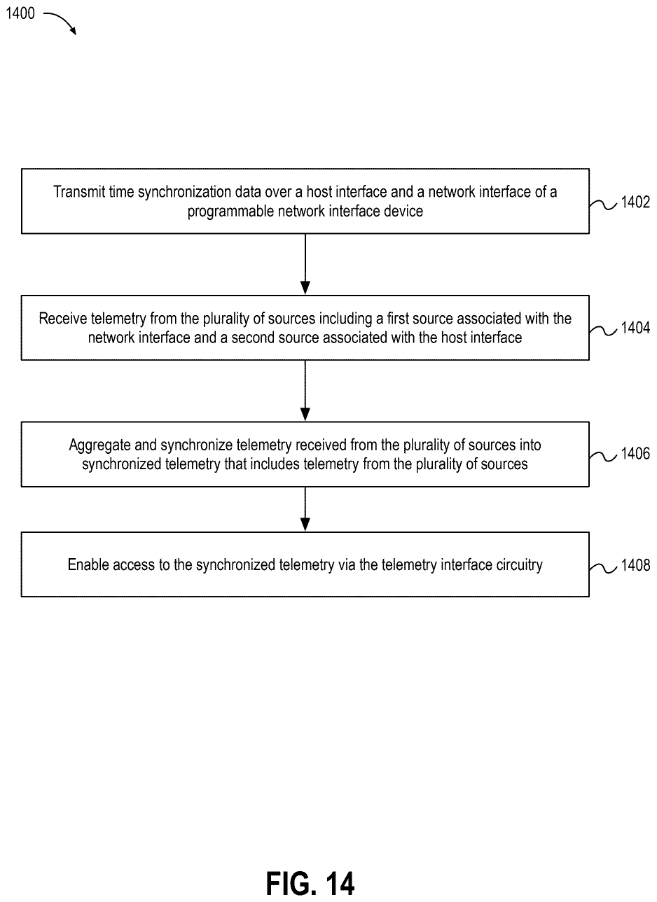

FIG. 14 illustrates a method 1400 of enabling time-based telemetry for networked devices, according to an embodiment. The method 1400 is implemented by a programmable network interface device described herein, such as the programmable network interface device 1000 of FIG. 10. The programmable network interface device can be configured to operate using the synchronization modes shown in FIG. 11A-11C. The programmable network interface device can also be configured to perform multi-device telemetry aggregation via the telemetry system 1200 of FIG. 12A-12B.

In one embodiment, the method 1400 includes to transmit time synchronization data over a host interface and a network interface of a programmable network interface device (1402). The time synchronization data can be transmitted over the host interface via PTM and over the network interface via IEEE PTP. In one embodiment, PTM is implemented over a PCIe host interconnect. In one embodiment a variant of PTM is implemented over a peer-to-peer device interconnect if such interconnect is available to the programmable network interface device. Devices coupled via the network interface and the host interface can synchronize their system clocks with nanosecond precision, enabling telemetry that is timestamped with nanosecond precision.

The programmable network interface device can then receive telemetry from the plurality of sources including a first source associated with the network interface and a second source associated with the host interface (1404). The first source may be, for example, a warehouse computer node that is communicatively coupled with the programmable network interface device via the network interface. The second source may be, for example, an accelerator device that is communicatively coupled with the programmable network interface device over a host interconnect. In one embodiment, the plurality of telemetry sources that are configured to transmit telemetry to the network interface device can be configured to participate in time synchronization in conjunction with configuring the sources to provide telemetry.

The programmable network interface device can then aggregate and synchronize telemetry received from the plurality of sources into synchronized telemetry that includes telemetry from the plurality of sources (1406). In one embodiment, the programmable network interface device can execute instructions to enable a monitoring engine via processor cores within an array of processor cores within a compute complex of the programmable network interface device. The programmable network interface device is configurable to enable access to the synchronized telemetry via the telemetry interface circuitry (1408). For example, a PF and associated VFs of the programmable network interface device can provide an interface though which telemetry monitoring hardware or software can access the synchronized telemetry.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device). This machine-readable storage medium may have instructions stored thereon, which when executed cause one or more processors to perform operations described herein.

In the drawings, some structural or method features may be shown in specific arrangements and/or orderings. However, it should be appreciated that such specific arrangements and/or orderings may not be required. In some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

Described herein are techniques to enable the generation of sharing of telemetry between network devices and host devices with timestamps that are synchronized at nanosecond precision. One embodiment provides a device that enables the synchronization and aggregation of telemetry data from multiple sources. The device includes a network interface, packet processing circuitry, and a host interface that provides access to physical functions. The physical functions are configured to transmit time synchronization data over the network interface and host interface via different time synchronization protocols, allowing for the synchronization of telemetry data from multiple sources. The device also receives telemetry data from these sources, which have timestamps determined by the respective time synchronization protocols. In one embodiment, the device includes circuitry that transmits the received telemetry data to a telemetry aggregator, which aggregates and synchronizes the data into synchronized telemetry that includes data from all sources, ordered by timestamp. The synchronized telemetry is then made accessible via telemetry interface circuitry. The telemetry aggregator can be provided by various means, including dedicated circuitry, processing circuitry executing program instructions, or a microcontroller executing firmware instructions. The telemetry can be transmitted to a telemetry aggregator that is accessible via the host interface or a telemetry aggregator that is accessible via the network interface. The telemetry aggregator can also be provided via program code executed via one or more processors of microcontrollers of the device.

One embodiment provides a method comprising transmitting time synchronization data over a network interface and a host interface using different time synchronization protocols to enable the synchronization of telemetry data from multiple sources, including those associated with the network interface and the host interface. The telemetry data is received from the multiple sources and includes timestamps determined by the respective time synchronization protocols. The received telemetry data is then aggregated and synchronized into an ordered dataset based on timestamps. This synchronized telemetry data is made accessible via telemetry interface circuitry. The aggregation and synchronization process can be facilitated by a telemetry aggregator, which can be configured to provide access to the telemetry data via the telemetry interface circuitry. The telemetry data can be transmitted to the telemetry aggregator via the network interface or the host interface. The telemetry aggregator can be provided through instructions executed by the processing circuitry of the programmable network interface device, which may include one or more processors or a microcontroller executing firmware instructions.

One embodiment provides a system including a memory device, a first host processor, a second host processor, and a network interface device. The network interface device includes a network interface, packet processing circuitry, and a host interface. The host interface has first circuitry that provides access to a first physical function and second circuitry that provides access to a second physical function. The first host processor is connected to the network interface device via the first physical function, and the second host processor is connected to the network interface device via the second physical function. One or both of the physical functions are configured to transmit time synchronization data to enable synchronization of telemetry from multiple sources over the network interface via a first time synchronization protocol and the host interface via a second time synchronization protocol. The system also receives telemetry from multiple sources, including a first source associated with the network interface and a second source associated with the host interface. The first source has telemetry with timestamps determined based on the first time synchronization protocol, and the second source has telemetry with timestamps determined based on the second time synchronization protocol.

The system can also include second circuitry that transmits the received telemetry to a telemetry aggregator, which is configured to enable access to the telemetry via telemetry interface circuitry. The telemetry aggregator aggregates and synchronizes the telemetry from multiple sources into synchronized telemetry, ordered by timestamp, and enables access to the synchronized telemetry via the telemetry interface circuitry. The second circuitry can transmit the telemetry to the telemetry aggregator via the network interface or the host interface. Alternatively, the system can include third circuitry that provides the telemetry aggregator, and the second circuitry transmits the telemetry to the telemetry aggregator provided by the third circuitry. The third circuitry includes one or more processors that execute program instructions or a microcontroller that executes firmware instructions to provide the telemetry aggregator.

The foregoing description and drawings are to be regarded in an illustrative rather than a restrictive sense. Persons skilled in the art will understand that various modifications and changes may be made to the embodiments described herein without departing from the broader spirit and scope of the features set forth in the appended claims.

What is claimed is:

1. A device comprising:
a network interface;
packet processing circuitry coupled with the network interface; and
a host interface coupled with the packet processing circuitry and the network interface, the host interface including first circuitry to provide access to a physical function, the physical function configured to:
transmit time synchronization data to enable synchronization of telemetry associated with a plurality of sources, the time synchronization data to be transmitted over the network interface via a first time synchronization protocol and the host interface via a second time synchronization protocol; and
receive telemetry from the plurality of sources including a first source associated with the network interface and a second source associated with the host interface, the first source having telemetry with timestamps determined at least in part based on the first time synchronization protocol and the second source having telemetry with timestamps determined at least in part based on the second time synchronization protocol.

2. The device of claim 1, comprising second circuitry to transmit the telemetry received from the plurality of sources to circuitry or instructions configured to provide a telemetry aggregator that is configured to enable access to the telemetry via telemetry interface circuitry.

3. The device of claim 2, the telemetry aggregator configured to:
aggregate and synchronize telemetry received from the plurality of sources into synchronized telemetry that includes telemetry from the plurality of sources ordered by timestamp; and
enable access to the synchronized telemetry via the telemetry interface circuitry.

4. The device of claim 2, wherein the second circuitry is configured to transmit the telemetry to the telemetry aggregator via the network interface.

5. The device of claim 2, wherein the second circuitry is configured to transmit the telemetry to the telemetry aggregator via the host interface.

6. The device of claim 2, comprising third circuitry to provide the telemetry aggregator, the second circuitry configured to provide the telemetry to the telemetry aggregator provided by the third circuitry.

7. The device of claim 6, the third circuitry including one or more processors to configured to execute program instructions to provide the telemetry aggregator.

8. The device of claim 6, the third circuitry including a microcontroller configured to execute firmware instructions to provide the telemetry aggregator.

9. A method comprising:
transmitting, via a programmable network interface device, time synchronization data over a network interface via a first time synchronization protocol and a host interface via a second time synchronization protocol to enable synchronization of telemetry associated with a plurality of sources;
receiving telemetry at the programmable network interface device from the plurality of sources, including a first source associated with the network interface and a second source associated with the host interface, the first source having telemetry with timestamps determined at least in part based on the first time synchronization protocol and the second source having telemetry with timestamps determined at least in part based on the second time synchronization protocol;
aggregating and synchronizing received telemetry into synchronized telemetry that includes telemetry from the plurality of sources ordered by timestamp; and
enabling access to the synchronized telemetry via telemetry interface circuitry.

10. The method of claim 9, comprising aggregating and synchronizing received telemetry via telemetry aggregator that is configured to enable access to the telemetry via the telemetry interface circuitry.

11. The method of claim 10, comprising transmitting the telemetry to the telemetry aggregator via the network interface.

12. The method of claim 10, comprising transmitting the telemetry to the telemetry aggregator via the host interface.

13. The method of claim 10, comprising providing the telemetry aggregator via instructions executed by processing circuitry of the programmable network interface device.

14. The method of claim 13, wherein the processing circuitry includes one or more processors to configured to execute program instructions to provide the telemetry aggregator or a microcontroller configured to execute firmware instructions to provide the telemetry aggregator.

15. A system comprising:
a memory device;
a first host processor coupled with the memory device;
a second host processor coupled with the memory device; and
a network interface device including:
a network interface;
packet processing circuitry coupled with the network interface; and
a host interface including first circuitry configured to provide access to a first physical function and second circuitry configured to provide access to a second physical function, the first host processor coupled with the network interface device via the first physical function, the second host processor coupled with the network interface device via the second physical function, and one or more of the first physical function and/or the second physical function configured to:
transmit time synchronization data to enable synchronization of telemetry associated with a plurality of sources, the time synchronization data to be transmitted over the network interface via a first time synchronization protocol and the host interface via a second time synchronization protocol; and
receive telemetry from the plurality of sources including a first source associated with the network interface and a second source associated with the host interface, the first source having telemetry with timestamps determined at least in part based on the first time synchronization protocol and the second source having telemetry with timestamps determined at least in part based on the second time synchronization protocol.

16. The system of claim 15, comprising second circuitry to transmit the telemetry received from the plurality of sources to circuitry or instructions configured to provide a telemetry aggregator that is configured to enable access to the telemetry via telemetry interface circuitry.

17. The system of claim 16, the telemetry aggregator configured to:
aggregate and synchronize telemetry received from the plurality of sources into synchronized telemetry that includes telemetry from the plurality of sources ordered by timestamp; and
enable access to the synchronized telemetry via the telemetry interface circuitry.

18. The system of claim 16, wherein the second circuitry is configured to transmit the telemetry to the telemetry aggregator via the network interface.

19. The system of claim 16, wherein the second circuitry is configured to transmit the telemetry to the telemetry aggregator via the host interface.

20. The system of claim 16, comprising third circuitry to provide the telemetry aggregator, the second circuitry configured to provide the telemetry to the telemetry aggregator provided by the third circuitry, the third circuitry including one or more processors to configured to execute program instructions to provide the telemetry aggregator or a microcontroller configured to execute firmware instructions to provide the telemetry aggregator.
